(19) United States
(12) Patent Application Publication
(10) Pub. No.: US 2025/0063616 A1
(43) Pub. Date: Feb. 20, 2025

(54) ENERGY HARVESTING FOR COMPONENT CARRIER AND BANDWIDTH PART PAIRINGS

(71) Applicant: QUALCOMM INCORPORATED, San Diego, CA (US)

(72) Inventors: Ahmed Elshafie, San Diego, CA (US); Ahmed Attia Abotabl, San Diego, CA (US); Alexandros Manolakos, Athens (GR); Yuchul Kim, San Diego, CA (US)

(21) Appl. No.: 18/720,584

(22) PCT Filed: Jan. 23, 2023
(86) PCT No.: PCT/US2023/061085

§ 371 Date: Jun. 14, 2024

(30) Foreign Application Priority Data
Feb. 3, 2022 (GR) 20220100111

(51) Int. Cl. H04W 76/14; H02J 50/00; H04W 24/10; H04W 52/36

(52) U.S. Cl. CPC H04W 76/14; H02J 50/001; H04W 24/10; H04W 52/365

(57) ABSTRACT

Methods, systems, and devices for wireless communications are described. A first device may receive a message indicating a configuration for performing an energy harvesting procedure. The configuration may indicate a pairing of a component carrier and a bandwidth part for the first device to use for performing the energy harvesting procedure. The pairing may be based on one or more measurements associated with the first device. As part of the energy harvesting procedure, the first device may monitor for one or more signals from a second device. The first device may monitor for the one or more signals using a set of resources that correspond to the pairing of the component carrier and the bandwidth part. The first device may receive, from the second device, one or more signals using the set of resources.

### CROSS REFERENCES

The present application is a 371 national stage filing of International PCT Application No. PCT/US2023/061085 by ELSHAFIE et al. entitled “ENERGY HARVESTING FOR COMPONENT CARRIER AND BANDWIDTH PART PAIRINGS,” filed Jan. 23, 2023; and claims priority to Greek Patent Application No. 20220100111 by ELSHAFIE et al. entitled “ENERGY HARVESTING FOR COMPONENT CARRIER AND BANDWIDTH PART PAIRINGS,” filed Feb. 3, 2022, each of which is assigned to the assignee hereof, and each of which is expressly incorporated by reference in its entirety herein.

### FIELD OF TECHNOLOGY

The following relates to wireless communications, including energy harvesting for component carrier and bandwidth part pairings.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM).

A wireless multiple-access communications system may include one or more base stations or one or more network access nodes, each simultaneously supporting communication for multiple communication devices, which may be otherwise known as user equipment (UE). In some wireless communications systems, a communication device may be configured to harvest energy from one or more signals received from another communication device.

### SUMMARY

The described techniques relate to improved methods, systems, devices, and apparatuses that support energy harvesting for component carrier and bandwidth part pairings. Generally, a first device may receive a message indicating a configuration for performing an energy harvesting procedure. The configuration may indicate a pairing of a component carrier and a bandwidth part for the first device to use for performing the energy harvesting procedure. In some examples, the pairing may be based on one or more measurements associated with the first device. As part of the energy harvesting procedure, the first device may monitor for one or more signals from a second device. For example, the first device may monitor for the one or more signals using a set of resources that correspond to the pairing of the component carrier and the bandwidth part. In some examples, the first device may receive, from the second device, one or more signals using the set of resources and perform energy harvesting accordingly.

A method for wireless communication at a first device is described. The method may include receiving a message indicating a configuration for performing an energy harvesting procedure by the first device, the configuration indicating a pairing of a component carrier and a bandwidth part for the first device to use for performing the energy harvesting procedure, the pairing based on one or more measurements associated with the first device and monitoring, as part of the energy harvesting procedure, for one or more signals from a second device using a set of resources that correspond to the pairing of the component carrier and the bandwidth part.

An apparatus for wireless communication at a first device is described. The apparatus may include a memory and a processor coupled to the memory. The processor may be configured to receive a message indicating a configuration for performing an energy harvesting procedure by the first device, the configuration indicating a pairing of a component carrier and a bandwidth part for the first device to use for performing the energy harvesting procedure, the pairing based on one or more measurements associated with the first device and monitor, as part of the energy harvesting procedure, for one or more signals from a second device using a set of resources that correspond to the pairing of the component carrier and the bandwidth part.

Another apparatus for wireless communication at a first device is described. The apparatus may include means for receiving a message indicating a configuration for performing an energy harvesting procedure by the first device, the configuration indicating a pairing of a component carrier and a bandwidth part for the first device to use for performing the energy harvesting procedure, the pairing based on one or more measurements associated with the first device and means for monitoring, as part of the energy harvesting procedure, for one or more signals from a second device using a set of resources that correspond to the pairing of the component carrier and the bandwidth part.

A non-transitory computer-readable medium storing code for wireless communication at a first device is described. The code may include instructions executable by a processor to receive a message indicating a configuration for performing an energy harvesting procedure by the first device, the configuration indicating a pairing of a component carrier and a bandwidth part for the first device to use for performing the energy harvesting procedure, the pairing based on one or more measurements associated with the first device and monitor, as part of the energy harvesting procedure, for one or more signals from a second device using a set of resources that correspond to the pairing of the component carrier and the bandwidth part.

Some examples of the method, apparatuses, and non-transitory computer-readable medium described herein may further include operations, features, means, or instructions for transmitting, to the second device, a report indicating a second pairing of a second component carrier and a second bandwidth part that satisfies a performance criterion based on the one or more measurements associated with the first device.

Some examples of the method, apparatuses, and non-transitory computer-readable medium described herein may further include operations, features, means, or instructions for receiving a power headroom report from the second device, where transmitting the report may be based on the power headroom report.

Some examples of the method, apparatuses, and non-transitory computer-readable medium described herein may further include operations, features, means, or instructions for transmitting the report including one or more communication link types and one or more pairings of a respective component carrier and a respective bandwidth part, where each of the one or more pairings corresponds to a respective communication link type of the one or more communication link types.

Some examples of the method, apparatuses, and non-transitory computer-readable medium described herein may further include operations, features, means, or instructions for receiving an indication of the one or more measurements from the second device, where transmitting the report may be based on the one or more measurements.

Some examples of the method, apparatuses, and non-transitory computer-readable medium described herein may further include operations, features, means, or instructions for combining two or more pairings of respective component carriers and respective bandwidth parts, where the set of resources corresponds to the combined two or more pairings of the respective component carriers and the respective bandwidth parts.

Some examples of the method, apparatuses, and non-transitory computer-readable medium described herein may further include operations, features, means, or instructions for transmitting, to the second device, a power headroom report indicating a transmit power availability of the first device, where the configuration for performing the energy harvesting procedure may be based on the transmit power availability of the first device.

Some examples of the method, apparatuses, and non-transitory computer-readable medium described herein may further include operations, features, means, or instructions for receiving one or more reference signals using one or more sets of resources, each of the one or more sets of resources corresponding to a respective pairing of a respective bandwidth part and a respective component carrier and performing measurements based on the one or more reference signals to obtain the one or more measurements associated with the first device.

Some examples of the method, apparatuses, and non-transitory computer-readable medium described herein may further include operations, features, means, or instructions for transmitting channel state information for one or more pairings of respective component carriers and bandwidth parts based on performing the measurements.

In some examples of the method, apparatuses, and non-transitory computer-readable medium described herein, performing the measurements may include operations, features, means, or instructions for measuring an energy expenditure associated with each respective pairing.

In some examples of the method, apparatuses, and non-transitory computer-readable medium described herein, performing the measurements may include operations, features, means, or instructions for measuring a current channel state information corresponding to each respective pairing.

In some examples of the method, apparatuses, and non-transitory computer-readable medium described herein, performing the measurements may include operations, features, means, or instructions for measuring an average channel state information corresponding to each respective pairing.

In some examples of the method, apparatuses, and non-transitory computer-readable medium described herein, measuring the average channel state information may include operations, features, means, or instructions for measuring an accumulation of acknowledgement or negative acknowledgement information corresponding to each pairing, an average charging rate across multiple transmissions measured for each pairing, an average statistic received from another device, or a combination thereof.

Some examples of the method, apparatuses, and non-transitory computer-readable medium described herein may further include operations, features, means, or instructions for transmitting a measurement report indicating the measurements of the one or more reference signals, where receiving the message indicating the configuration for performing the energy harvesting procedure may be based on transmitting the measurement report.

Some examples of the method, apparatuses, and non-transitory computer-readable medium described herein may further include operations, features, means, or instructions for receiving, from the second device and using the set of resources that correspond to the pairing of the component carrier and the bandwidth part, at least one signal of the one or more signals, the at least one signal comprising a data signal; decoding the at least one signal based on the at least one signal comprising the data signal; and performing the energy harvesting procedure to convert at least a portion of the at least one signal to power to be used at the first device.

In some examples of the method, apparatuses, and non-transitory computer-readable medium described herein, receiving the message indicating the configuration for performing the energy harvesting procedure may include operations, features, means, or instructions for receiving the message from the second device, or a third device different from the second device and the first device.

A method for wireless communication at a first device is described. The method may include transmitting a message indicating a configuration for performing an energy harvesting procedure by a second device, the configuration indicating a pairing of a component carrier and a bandwidth part for the second device to use for performing the energy harvesting procedure, the pairing based on one or more measurements associated with the second device and transmitting, as part of the energy harvesting procedure, one or more signals to the second device using a set of resources that correspond to the pairing of the component carrier and the bandwidth part.

An apparatus for wireless communication at a first device is described. The apparatus may include a memory and a processor coupled to the memory. The processor may be configured to transmit a message indicating a configuration for performing an energy harvesting procedure by a second device, the configuration indicating a pairing of a component carrier and a bandwidth part for the second device to use for performing the energy harvesting procedure, the pairing based on one or more measurements associated with the second device and transmit, as part of the energy harvesting procedure, one or more signals to the second device using a set of resources that correspond to the pairing of the component carrier and the bandwidth part.

Another apparatus for wireless communication at a first device is described. The apparatus may include means for transmitting a message indicating a configuration for performing an energy harvesting procedure by a second device, the configuration indicating a pairing of a component carrier and a bandwidth part for the second device to use for performing the energy harvesting procedure, the pairing based on one or more measurements associated with the second device and means for transmitting, as part of the energy harvesting procedure, one or more signals to the second device using a set of resources that correspond to the pairing of the component carrier and the bandwidth part.

A non-transitory computer-readable medium storing code for wireless communication at a first device is described. The code may include instructions executable by a processor to transmit a message indicating a configuration for performing an energy harvesting procedure by a second device, the configuration indicating a pairing of a component carrier and a bandwidth part for the second device to use for performing the energy harvesting procedure, the pairing based on one or more measurements associated with the second device and transmit, as part of the energy harvesting procedure, one or more signals to the second device using a set of resources that correspond to the pairing of the component carrier and the bandwidth part.

Some examples of the method, apparatuses, and non-transitory computer-readable medium described herein may further include operations, features, means, or instructions for receiving, from the second device, a report indicating a second pairing of a second component carrier and a second bandwidth part that satisfies a performance criterion based on the one or more measurements associated with the second device.

Some examples of the method, apparatuses, and non-transitory computer-readable medium described herein may further include operations, features, means, or instructions for transmitting a power headroom report to the second device, where receiving the report may be based on the power headroom report.

Some examples of the method, apparatuses, and non-transitory computer-readable medium described herein may further include operations, features, means, or instructions for receiving the report including one or more communication link types and one or more pairings of a respective component carrier and a respective bandwidth part, where each of the one or more pairings corresponds to a respective communication link type of the one or more communication link types.

Some examples of the method, apparatuses, and non-transitory computer-readable medium described herein may further include operations, features, means, or instructions for transmitting an indication of the one or more measurements to the second device, where receiving the report may be based on the one or more measurements.

Some examples of the method, apparatuses, and non-transitory computer-readable medium described herein may further include operations, features, means, or instructions for receiving, from the second device, a power headroom report indicating a transmit power availability of the first device, where the configuration for performing the energy harvesting procedure may be based on the transmit power availability of the first device.

Some examples of the method, apparatuses, and non-transitory computer-readable medium described herein may further include operations, features, means, or instructions for transmitting one or more reference signals using one or more sets of resources, each of the one or more sets of resources corresponding to a respective pairing of a respective bandwidth part and a respective component carrier and performing measurements based on the one or more reference signals to obtain the one or more measurements associated with the second device.

Some examples of the method, apparatuses, and non-transitory computer-readable medium described herein may further include operations, features, means, or instructions for transmitting channel state information for one or more pairings of respective component carriers and bandwidth parts based on performing the measurements.

In some examples of the method, apparatuses, and non-transitory computer-readable medium described herein, performing the measurements may include operations, features, means, or instructions for measuring an energy expenditure associated with each respective pairing.

In some examples of the method, apparatuses, and non-transitory computer-readable medium described herein, performing the measurements may include operations, features, means, or instructions for measuring a current channel state information corresponding to each respective pairing.

In some examples of the method, apparatuses, and non-transitory computer-readable medium described herein, performing the measurements may include operations, features, means, or instructions for measuring an average channel state information corresponding to each respective pairing.

In some examples of the method, apparatuses, and non-transitory computer-readable medium described herein, measuring the average channel state information may include operations, features, means, or instructions for measuring an accumulation of acknowledgement or negative acknowledgement information corresponding to each pairing, an average charging rate across multiple transmissions measured for each pairing, an average statistic received from another device, or a combination thereof.

Some examples of the method, apparatuses, and non-transitory computer-readable medium described herein may further include operations, features, means, or instructions for receiving a measurement report indicating the measurements of the one or more reference signals, where transmitting the message indicating the configuration for performing the energy harvesting procedure may be based on receiving the measurement report.

In some examples of the method, apparatuses, and non-transitory computer-readable medium described herein, transmitting the message indicating the configuration for performing the energy harvesting procedure may include operations, features, means, or instructions for transmitting the message from the second device, or a third device different from the second device and the first device.

### BRIEF DESCRIPTION OF THE DRAWINGS

FIGS. 1 through 3 each illustrate an example of a wireless communications system that supports energy harvesting for component carrier and bandwidth part pairings in accordance with aspects of the present disclosure.

FIG. 4 illustrates an example of a process flow that supports energy harvesting for component carrier and bandwidth part pairings in accordance with aspects of the present disclosure.

FIGS. 5 and 6 show block diagrams of devices that support energy harvesting for component carrier and bandwidth part pairings in accordance with aspects of the present disclosure.

FIG. 7 shows a block diagram of a communications manager that supports energy harvesting for component carrier and bandwidth part pairings in accordance with aspects of the present disclosure.

FIG. 8 shows a diagram of a system including a device that supports energy harvesting for component carrier and bandwidth part pairings in accordance with aspects of the present disclosure.

FIGS. 9 and 10 show block diagrams of devices that support energy harvesting for component carrier and bandwidth part pairings in accordance with aspects of the present disclosure.

FIG. 11 shows a block diagram of a communications manager that supports energy harvesting for component carrier and bandwidth part pairings in accordance with aspects of the present disclosure.

FIG. 12 shows a diagram of a system including a device that supports energy harvesting for component carrier and bandwidth part pairings in accordance with aspects of the present disclosure.

FIGS. 13 through 16 show flowcharts illustrating methods that support energy harvesting for component carrier and bandwidth part pairings in accordance with aspects of the present disclosure.

### DETAILED DESCRIPTION

Wireless communications systems may support communication links between communication devices (e.g., such as a base station, a user equipment (UE), and an integrated access and backhaul (IAB) node), such that the devices may communicate in various radio frequency spectrum bands. For example, the devices may operate over a carrier bandwidth. In some examples, a carrier bandwidth may be divided into multiple bandwidth parts that may be used for communication with the device. Each bandwidth part may include a contiguous set of resource blocks (RBs) on a carrier bandwidth and different bandwidth parts may or may not be contiguous in frequency. For example, a bandwidth part may be adjacent in frequency to another bandwidth part or a bandwidth part may have gaps or guard bands to adjacent bandwidth parts. In some examples, bandwidth parts may be configured with different parameters (e.g., protocol features, numerologies, modulation schemes, physical channels). For example, one or more bandwidth parts may be defined on a component carrier and each bandwidth part may have a defined bandwidth and set of properties. For example, a New Radio (NR) may configure multiple component carriers and one or more (e.g., up to about four or more) bandwidth parts per component carrier for uplink and downlink.

In some wireless communications systems, a device may perform energy harvesting, for example for powering a device or to supplement or achieve battery charging at the device. For example, a device (e.g., a receiving device) may receive a signal, such as a radio frequency signal, from another device (e.g., a transmitting device). The device may use energy from the signal to charge a battery at the device or otherwise provide power for performing one or more operations at the device. The device may, for example, harvest energy from the received signal to charge a battery of the device, perform data encoding, perform data decoding, perform filtering operations, transmit data, receive data, or perform any combination of these processes or other processes.

In some examples, monitoring for signals to perform energy harvesting may be power consuming. For example, the device may consume an amount of power monitoring for signals transmitted from one or more other devices. In some examples, the amount of power consumed by the device may depend on the component carrier and bandwidth part pair being monitored. For example, the amount of power consumed by the device may increase as the number of component carriers monitored by the device increases or as the size (e.g., bandwidth) of the bandwidth part of a component carrier monitored by the device increases. As such, monitoring a relatively high number of component carriers or a relatively large bandwidth part of a component carrier may become prohibitive for some devices, such as reduced capability devices or devices operating at a relatively low power, among other examples.

Various aspects of the present disclosure relate to energy harvesting for component carrier and bandwidth part pairings. For example, to increase energy performance at a device, the device may determine a component carrier and bandwidth part pair to use for energy harvesting based on energy costs (e.g., power consumption) associated with monitoring particular component carrier and bandwidth part pairs. In some examples, a first device (e.g., a transmitting device) may select a component carrier and bandwidth part pair for transmitting signals to be used for energy harvesting (e.g., energy harvesting signals) based on measurements performed at the first device or based on measurements performed at a second device (e.g., the receiving device, the device performing the energy harvesting) and reported to the first device. For example, the first device may select the component carrier and bandwidth part pair based on a charging rate, channel state information (CSI), or one or more statistics, among other examples. The measurements may include instantaneous (e.g., current) measurements from multiple (e.g., different) active component carriers on active bandwidth parts or based on an average of multiple measurements (e.g., performed over a period of time) from multiple (e.g., different) component carriers across bandwidth parts (e.g., active bandwidth parts or inactive bandwidth parts).

For example, the instantaneous measurements may include instantaneous charging rates, CSI, or one or more statistics (e.g., associated with each component carrier and bandwidth part pair) measured at the second device (e.g., and reported to the first device) for each active component carrier on active bandwidth parts. In some examples, the first device may determine (e.g., compute) instantaneous charging rates based on reference signals, such as sounding reference signals, transmitted by the second device. The average measurements may include an average charging rate, an average CSI, or one or more average statistics measured across multiple transmissions per component carrier and bandwidth part pair. In some examples, the first device may determine the average CSI based on an accumulation of acknowledgement (e.g., or negative acknowledgement) messages transmitted by the receiving device for one or multiple component carrier and bandwidth part pairs.

Particular aspects of the subject matter described herein may be implemented to realize one or more potential advantages associated with techniques that support energy harvesting for component carrier and bandwidth part pairings. For example, the described techniques may support the selection of component carrier and bandwidth part pairs to reduce energy costs associated with energy harvesting. For example, by selecting a component carrier and bandwidth part for transmitting energy harvesting signals, a first device may reduce power consumption at a second device thereby increasing energy performance and communication resource efficiency, among other benefits.

Aspects of the disclosure are initially described in the context of wireless communications systems. Aspects of the disclosure are further illustrated by and described with reference to a process flow, apparatus diagrams, system diagrams, and flowcharts that relate to energy harvesting for component carrier and bandwidth part pairings.

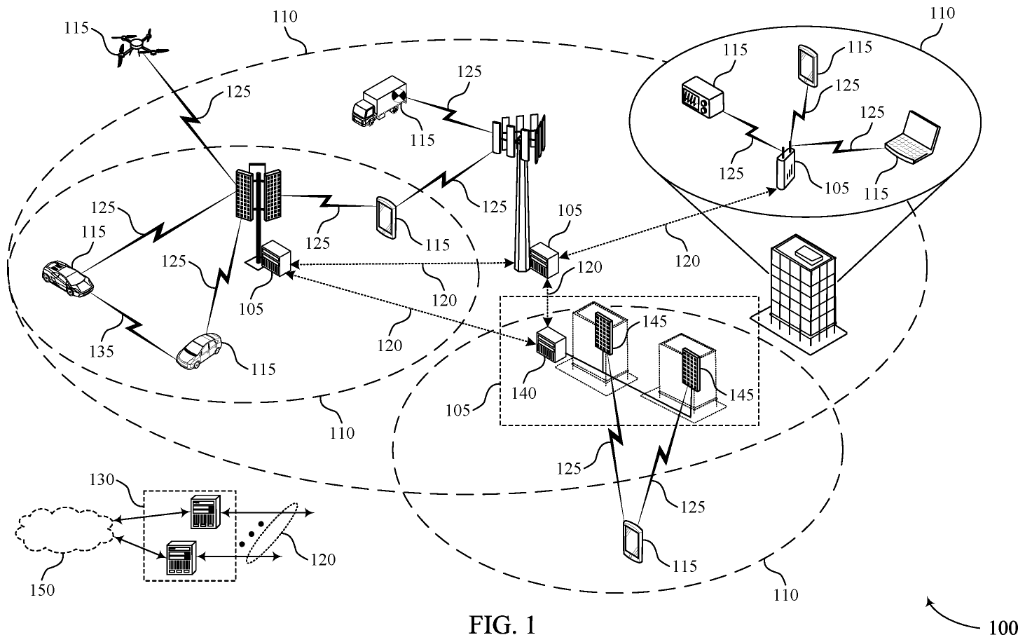

FIG. 1 illustrates an example of a wireless communications system 100 that supports energy harvesting for component carrier and bandwidth part pairings in accordance with aspects of the present disclosure. The wireless communications system 100 may include one or more base stations 105, one or more UEs 115, and a core network 130. In some examples, the wireless communications system 100 may be a Long Term Evolution (LTE) network, an LTE-Advanced (LTE-A) network, an LTE-A Pro network, or a NR network. In some examples, the wireless communications system 100 may support enhanced broadband communications, ultra-reliable communications, low latency communications, communications with low-cost and low-complexity devices, or any combination thereof.

The base stations 105 may be dispersed throughout a geographic area to form the wireless communications system 100 and may be devices in different forms or having different capabilities. The base stations 105 and the UEs 115 may wirelessly communicate via one or more communication links 125. Each base station 105 may provide a coverage area 110 over which the UEs 115 and the base station 105 may establish one or more communication links 125. The coverage area 110 may be an example of a geographic area over which a base station 105 and a UE 115 may support the communication of signals according to one or more radio access technologies.

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be able to communicate with various types of devices, such as other UEs 115, the base stations 105, or network equipment (e.g., core network nodes, relay devices, IAB nodes, or other network equipment), as shown in FIG. 1.

In some examples, one or more components of the wireless communications system 100 may operate as or be referred to as a network node. As used herein, a network node may refer to any UE 115, base station 105, entity of a core network 130, apparatus, device, or computing system configured to perform any techniques described herein. For example, a network node may be a UE 115. As another example, a network node may be a base station 105. As another example, a first network node may be configured to communicate with a second network node or a third network node. In one aspect of this example, the first network node may be a UE 115, the second network node may be a base station 105, and the third network node may be a UE 115. In another aspect of this example, the first network node may be a UE 115, the second network node may be a base station 105, and the third network node may be a base station 105. In yet other aspects of this example, the first, second, and third network nodes may be different. Similarly, reference to a UE 115, a base station 105, an apparatus, a device, or a computing system may include disclosure of the UE 115, base station 105, apparatus, device, or computing system being a network node. For example, disclosure that a UE 115 is configured to receive information from a base station 105 also discloses that a first network node is configured to receive information from a second network node. In this example, consistent with this disclosure, the first network node may refer to a first UE 115, a first base station 105, a first apparatus, a first device, or a first computing system configured to receive the information; and the second network node may refer to a second UE 115, a second base station 105, a second apparatus, a second device, or a second computing system.

The base stations 105 may communicate with the core network 130, or with one another, or both. For example, the base stations 105 may interface with the core network 130 through one or more backhaul links 120 (e.g., via an S1, N2, N3, or other interface). The base stations 105 may communicate with one another over the backhaul links 120 (e.g., via an X2, Xn, or other interface) either directly (e.g., directly between base stations 105), or indirectly (e.g., via core network 130), or both. In some examples, the backhaul links 120 may be or include one or more wireless links.

One or more of the base stations 105 described herein may include or may be referred to by a person having ordinary skill in the art as a base transceiver station, a radio base station, an access point, a radio transceiver, a NodeB, an eNodeB (eNB), a next-generation NodeB or a giga-NodeB (either of which may be referred to as a gNB), a Home NodeB, a Home eNodeB, or other suitable terminology.

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the base stations 105 and the network equipment including macro eNBs or gNBs, small cell eNBs or gNBs, or relay base stations, among other examples, as shown in FIG. 1.

The UEs 115 and the base stations 105 may wirelessly communicate with one another via one or more communication links 125 over one or more carriers. The term “carrier” may refer to a set of radio frequency spectrum resources having a defined physical layer structure for supporting the communication links 125. For example, a carrier used for a communication link 125 may include a portion of a radio frequency spectrum band (e.g., a bandwidth part (bandwidth part)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers.

A carrier may be associated with a particular bandwidth of the radio frequency spectrum, and in some examples the carrier bandwidth may be referred to as a “system bandwidth” of the carrier or the wireless communications system 100. For example, the carrier bandwidth may be one of a number of determined bandwidths for carriers of a particular radio access technology (e.g., 1.4, 3, 5, 10, 15, 20, 40, or 80 megahertz (MHz)). Devices of the wireless communications system 100 (e.g., the base stations 105, the UEs 115, or both) may have hardware configurations that support communications over a particular carrier bandwidth or may be configurable to support communications over one of a set of carrier bandwidths. In some examples, the wireless communications system 100 may include base stations 105 or UEs 115 that support simultaneous communications via carriers associated with multiple carrier bandwidths. In some examples, each served UE 115 may be configured for operating over portions (e.g., a sub-band, a bandwidth part) or all of a carrier bandwidth.

Signal waveforms transmitted over a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may consist of one symbol period (e.g., a duration of one modulation symbol) and one subcarrier, where the symbol period and subcarrier spacing are inversely related. The number of bits carried by each resource element may depend on the modulation scheme (e.g., the order of the modulation scheme, the coding rate of the modulation scheme, or both). Thus, the more resource elements that a UE 115 receives and the higher the order of the modulation scheme, the higher the data rate may be for the UE 115. A wireless communications resource may refer to a combination of a radio frequency spectrum resource, a time resource, and a spatial resource (e.g., spatial layers or beams), and the use of multiple spatial layers may further increase the data rate or data integrity for communications with a UE 115.

One or more numerologies for a carrier may be supported, where a numerology may include a subcarrier spacing (Δƒ) and a cyclic prefix. A carrier may be divided into one or more bandwidth parts having the same or different numerologies. In some examples, a UE 115 may be configured with multiple bandwidth parts. In some examples, a single bandwidth part for a carrier may be active at a given time and communications for the UE 115 may be restricted to one or more active bandwidth parts.

The time intervals for the base stations 105 or the UEs 115 may be expressed in multiples of a basic time unit which may, for example, refer to a sampling period of Tₛ=1/(Δƒₘₐₓ·N_{ƒ}) seconds, where Δƒₘₐₓ may represent the maximum supported subcarrier spacing, and N_{ƒ} may represent the maximum supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively numbered subframes or slots, and each subframe or slot may have the same duration. In some examples, a frame may be divided (e.g., in the time domain) into subframes, and each subframe may be further divided into a number of slots. Alternatively, each frame may include a variable number of slots, and the number of slots may depend on subcarrier spacing. Each slot may include a number of symbol periods (e.g., depending on the length of the cyclic prefix prepended to each symbol period). In some wireless communications systems 100, a slot may further be divided into multiple mini-slots containing one or more symbols. Excluding the cyclic prefix, each symbol period may contain one or more (e.g., N_{ƒ}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., the number of symbol periods in a TTI) may be variable. Additionally or alternatively, the smallest scheduling unit of the wireless communications system 100 may be dynamically selected (e.g., in bursts of shortened TTIs (sTTIs)).

Physical channels may be multiplexed on a carrier according to various techniques. A physical control channel and a physical data channel may be multiplexed on a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a number of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to a number of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

In some examples, a base station 105 may be movable and therefore provide communication coverage for a moving geographic coverage area 110. In some examples, different geographic coverage areas 110 associated with different technologies may overlap, but the different geographic coverage areas 110 may be supported by the same base station 105. In other examples, the overlapping geographic coverage areas 110 associated with different technologies may be supported by different base stations 105. The wireless communications system 100 may include, for example, a heterogeneous network in which different types of the base stations 105 provide coverage for various geographic coverage areas 110 using the same or different radio access technologies.

Some UEs 115, such as MTC or IoT devices, may be low cost or low complexity devices and may provide for automated communication between machines (e.g., via Machine-to-Machine (M2M) communication). M2M communication or MTC may refer to data communication technologies that allow devices to communicate with one another or a base station 105 without human intervention. In some examples, M2M communication or MTC may include communications from devices that integrate sensors or meters to measure or capture information and relay such information to a central server or application program that makes use of the information or presents the information to humans interacting with the application program. Some UEs 115 may be designed to collect information or enable automated behavior of machines or other devices. Examples of applications for MTC devices include smart metering, inventory monitoring, water level monitoring, equipment monitoring, healthcare monitoring, wildlife monitoring, weather and geological event monitoring, fleet management and tracking, remote security sensing, physical access control, and transaction-based business charging.

Some UEs 115 may be configured to employ operating modes that reduce power consumption, such as half-duplex communications (e.g., a mode that supports one-way communication via transmission or reception, but not transmission and reception simultaneously). In some examples, half-duplex communications may be performed at a reduced peak rate. Other power conservation techniques for the UEs 115 include entering a power saving deep sleep mode when not engaging in active communications, operating over a limited bandwidth (e.g., according to narrowband communications), or a combination of these techniques. For example, some UEs 115 may be configured for operation using a narrowband protocol type that is associated with a defined portion or range (e.g., set of subcarriers or resource blocks (RBs)) within a carrier, within a guard-band of a carrier, or outside of a carrier.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may also be able to communicate directly with other UEs 115 over a device-to-device (D2D) communication link 135 (e.g., using a peer-to-peer (P2P) or D2D protocol). One or more UEs 115 utilizing D2D communications may be within the geographic coverage area 110 of a base station 105. Other UEs 115 in such a group may be outside the geographic coverage area 110 of a base station 105 or be otherwise unable to receive transmissions from a base station 105. In some examples, groups of the UEs 115 communicating via D2D communications may utilize a one-to-many (1:M) system in which each UE 115 transmits to every other UE 115 in the group. In some examples, a base station 105 facilitates the scheduling of resources for D2D communications. In other cases, D2D communications are carried out between the UEs 115 without the involvement of a base station 105.

In some systems, the D2D communication link 135 may be an example of a communication channel, such as a sidelink communication channel, between vehicles (e.g., UEs 115). In some examples, vehicles may communicate using vehicle-to-everything (V2X) communications, vehicle-to-vehicle (V2V) communications, or some combination of these. A vehicle may signal information related to traffic conditions, signal scheduling, weather, safety, emergencies, or any other information relevant to a V2X system. In some examples, vehicles in a V2X system may communicate with roadside infrastructure, such as roadside units, or with the network via one or more network nodes (e.g., base stations 105) using vehicle-to-network (V2N) communications, or with both.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the base stations 105 associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

Some of the network devices, such as a base station 105, may include subcomponents such as an access network entity 140, which may be an example of an access node controller (ANC). Each access network entity 140 may communicate with the UEs 115 through one or more other access network transmission entities 145, which may be referred to as radio heads, smart radio heads, or transmission/reception points (TRPs). Each access network transmission entity 145 may include one or more antenna panels. In some configurations, various functions of each access network entity 140 or base station 105 may be distributed across various network devices (e.g., radio heads and ANCs) or consolidated into a single network device (e.g., a base station 105).

The wireless communications system 100 may operate using one or more frequency bands, typically in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. The UHF waves may be blocked or redirected by buildings and environmental features, but the waves may penetrate structures sufficiently for a macro cell to provide service to the UEs 115 located indoors. The transmission of UHF waves may be associated with smaller antennas and shorter ranges (e.g., less than 100 kilometers) compared to transmission using the smaller frequencies and longer waves of the high frequency (HF) or very high frequency (VHF) portion of the spectrum below 300 MHz.

The wireless communications system 100 may utilize both licensed and unlicensed radio frequency spectrum bands. For example, the wireless communications system 100 may employ License Assisted Access (LAA), LTE-Unlicensed (LTE-U) radio access technology, or NR technology in an unlicensed band such as the 5 GHz industrial, scientific, and medical (ISM) band. When operating in unlicensed radio frequency spectrum bands, devices such as the base stations 105 and the UEs 115 may employ carrier sensing for collision detection and avoidance. In some examples, operations in unlicensed bands may be based on a carrier aggregation configuration in conjunction with component carriers operating in a licensed band (e.g., LAA). Operations in unlicensed spectrum may include downlink transmissions, uplink transmissions, P2P transmissions, or D2D transmissions, among other examples.

A base station 105 or a UE 115 may be equipped with multiple antennas, which may be used to employ techniques such as transmit diversity, receive diversity, multiple-input multiple-output (MIMO) communications, or beamforming. The antennas of a base station 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a base station 105 may be located in diverse geographic locations. A base station 105 may have an antenna array with a number of rows and columns of antenna ports that the base station 105 may use to support beamforming of communications with a UE 115. Likewise, a UE 115 may have one or more antenna arrays that may support various MIMO or beamforming operations. Additionally or alternatively, an antenna panel may support radio frequency beamforming for a signal transmitted via an antenna port.

Beamforming, which may also be referred to as spatial filtering, directional transmission, or directional reception, is a signal processing technique that may be used at a transmitting device or a receiving device (e.g., a base station 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating at particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

In some examples of wireless communications system 100, a first device (e.g., a UE 115, a base station 105, or an IAB node (not shown)) may receive a message indicating a configuration for performing an energy harvesting procedure. The configuration may indicate a pairing of a component carrier and a bandwidth part for the first device to use for performing the energy harvesting procedure. In some examples, the pairing may be based on one or more measurements associated with the first device. As part of the energy harvesting procedure, the first device may monitor for one or more signals from a second device (e.g., another UE 115, another base station 105, or another IAB node). For example, the first device may monitor for the one or more signals using a set of resources that correspond to the pairing of the component carrier and the bandwidth part. In some examples, the first device may receive, from the second device, one or more signals using the set of resources, thereby reducing power costs at the second device.

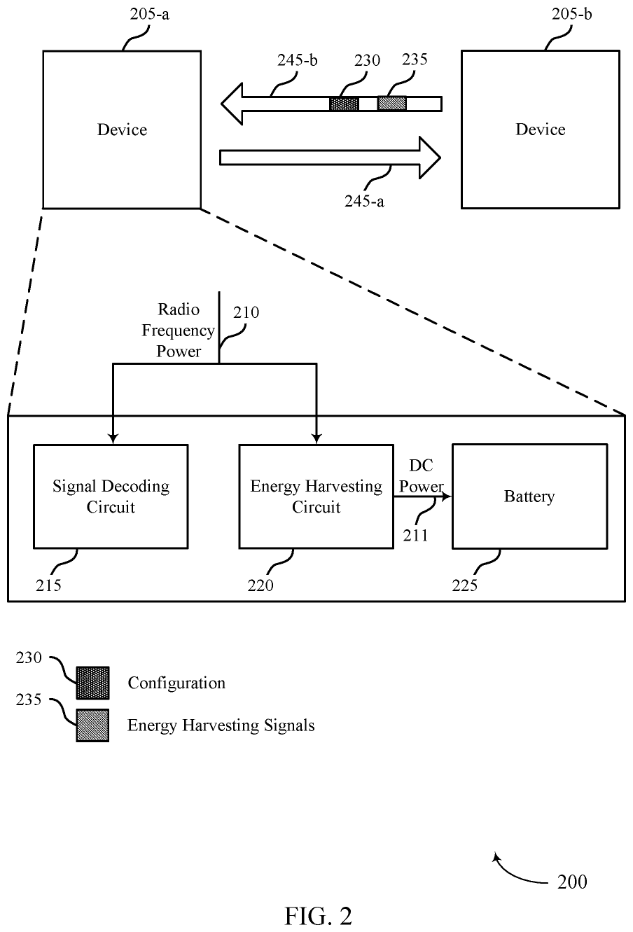

FIG. 2 illustrates an example of a wireless communications system 200 that supports energy harvesting for component carrier and bandwidth part pairings in accordance with aspects of the present disclosure. In some examples, the wireless communications system 200 may implement aspects of wireless communications system 100. For example, the wireless communications system 200 may include one or more devices 205 (e.g., a device 205-a and a device 205-b), which may be examples of a UE 115, a base station 105, an IAB node, or any other device as described with reference to FIG. 1. In the examples of FIG. 2, the device 205-a may be a receiving device and the device 205-b may be a transmitting device. Additionally or alternatively, in the example of FIG. 2, the devices 205 may be reduced capability devices, which may be referred to as RedCap devices, or non-reduced capability devices.

Additionally or alternatively, the devices 205 may communicate over one or more communication links 245 (e.g., a communication link 245-a or a communication link 245-b). The communication links 245 (e.g., wired or wireless communication links) may be network links (e.g., downlinks or uplinks) or direct links (e.g., sidelinks). For example, a UE to base station link (e.g., a network link) in a cellular network may occur over the UTRAN to UE (Uu) interface and may be referred to as be referred to as Uu links. Additionally or alternatively, wireless communication links between UEs (e.g., or UEs and other communication devices) may occur over the PC5 interface and may be referred to as sidelinks. For example, sidelink may be used for D2D communication between UEs. Additionally or alternatively, sidelink may be used as a relay for network coverage extension and power saving (e.g., for a reduced capability UE). In some examples of sidelink communication techniques, before wireless devices may communicate, a device may first detect the presence of another device. In some examples, this process may be referred to as sidelink discovery for sidelink communications.

The wireless communications system 200 may support various techniques for energy harvesting. For example, the devices 205 (e.g., energy harvesting powered devices) may opportunistically harvest energy in the environment, such as solar, heat, and ambient radio frequency radiation and store the energy in a rechargeable battery. Energy harvesting may include acquiring energy from an energy source (e.g., a radio frequency wave, a conducting wire) and using or storing the acquired energy for tasks that may correspond to, or otherwise be associated with, energy harvesting. In some examples, the device 205-a may be configured to perform energy harvesting. That is, the device 205-a may include an energy harvesting circuit 220 that may be capable of converting received power (e.g., radio frequency power) to direct current (DC) power. In some examples, the device 205-a may then store the DC power (e.g., converted by the energy harvesting circuit 220 from radio frequency power) at a battery 225 of the device 205-a. As such, radio frequency sources (e.g., radio frequency transmissions) may provide controllable and relatively constant energy transfer over distances. That is, while a device operating on intermittently available energy harvested from the environment may not sustain relatively long continuous reception or transmission, and while the amount of harvest energy (e.g., energy harvesting signal traffic) may vary, energy harvested by energy harvesting devices (e.g., the device 205-a) may be predictable and relatively stable over time.

In some examples, the device 205-a may be configured to both harvest radio frequency energy (e.g., using the energy harvesting circuit 220) and decode radio frequency transmissions (e.g., using a signal decoding circuit 215). For example, the energy harvesting circuit 220 (e.g., a radio frequency energy harvester) may include an antenna, an impedance matching network, a voltage multiplier, and a capacitor. Additionally or alternatively, the voltage multiplier may include diodes of a rectifying circuit which may convert radio frequency signals (e.g., alternating current signals in the environment of the device 205-a) into DC voltage.

For example, the device 205-b may transmit energy harvesting signals 235 (e.g., with a determined radio frequency power 210) to the device 205-a. Here, the device 205-a may include the signal decoding circuit 215 to receive and decode the energy harvesting signal 235 from device 205-b. Additionally or alternatively, the device 205-a may include the energy harvesting circuit 220 to convert at least a portion of the radio frequency power 210 of the energy harvesting signal 235 to DC power 211. In some examples, multiple (e.g., different) forms of backscatter communication based devices (e.g., passive IoT devices) in which a battery-less device collects energy from signal in the environment of the device (e.g., ambient radio frequency signals) and redirects the energy, may use one or multiple other components, such as radio frequency identification (RFID) tags and power consuming radio frequency components (e.g., an analog to digital converter (ADC), a mixer, and oscillators).

The energy harvesting circuit 220 and the signal decoding circuit 215 may be included as part of a separated receiver architecture, a time-switching architecture, or a power-splitting architecture. The energy harvesting circuit 220 may convert energy from an electromagnetic domain to an electrical domain. For example, the energy harvesting circuit 220 may receive the radio frequency power 210 (e.g., having power associated with an electromagnetic field) and may convert the radio frequency power 210 to the DC power 211 (e.g., having power associated with a voltage and current). As such, the device 205-a may convert at least a portion of the received radio frequency power 210 to the DC power 211 and store the converted DC power 211 at the device 205-a (e.g., within the battery 225). In some examples, the device 205-a may use the stored energy to perform low energy tasks including tasks associated with information transfer such as decoding or encoding data, analog-to-digital signal conversion, processing reference signals, transmitting reference signals, operations while in an idle or otherwise inactive state, or other tasks that are associated with relatively low energy consumption (e.g., when compared to other tasks performed by the device 205-a that consume energy).

The energy harvested by the device 205-a may depend on a number of factors. For example, an energy harvesting device (e.g., the device 205-a) may experience a radio frequency and hardware cost, as well as power cost, for performing energy harvesting with a particular component carrier and bandwidth part pair. In some examples, the cost may be prohibitive for energy harvesting devices operating at a relatively low power (e.g., reduced capability devices, IoT devices, wearable devices) and operating on an increased number of frequency bands may result in increased power loss at the device (e.g., if the frequency bands are used for collecting energy and no or relatively few transmissions occur).

In some examples, the efficiency of the radio frequency harvester at the device 205-a (e.g., the energy harvesting circuit 220) may depend on the efficiency of the antenna, the accuracy of the impedance matching between the antenna and the voltage multiplier, and the power efficiency of the voltage multiplier (e.g., that converts the received radio frequency signals to the DC voltage). For example, the efficiency of the energy harvesting circuit 220 may increase (e.g., from about 10 percent to about 45 percent) as the receive power (e.g., at the device 205-a) increases (e.g., from about-30 decibel milliwatts (dBm) to about-10 dBm).

In some examples, the efficiency of the radio frequency harvester may be described according to a linear model. In some examples of the linear model, the radio frequency energy harvesting efficiency (n) may be described according to the following Equation 1:

$$η = {P}_{out} / {P}_{i n} \qquad ( 1 )$$

where, Pₒᵤₜ may represent the harvested power (e.g., the power output by the energy harvesting circuit 220) and Pᵢₙ may represent the input power to the energy harvesting circuit 220. In some examples, η (e.g., the radio frequency to DC conversion efficiency) may be independent of Pᵢₙ. For example, and in accordance with Equation 1, the harvested power (Pₒᵤₜ) may be described according to the following Equation 2:

$${P}_{out} = η \times {P}_{i n} . \qquad ( 2 )$$

Additionally or alternatively, the efficiency of the radio frequency harvester may be described according to a radio frequency energy harvester model. In some examples of the radio frequency energy harvester model, the harvested power (Pₒᵤₜ) may be described according to the following Equation 3:

$${P}_{out} = f ( {P}_{in} ) \qquad ( 3 )$$

where, ƒ(·) may represent an input-output power function. Additionally or alternatively, the radio efficiency of the radio frequency harvester may be described according to a non-linear model in which the harvested power (Pₒᵤₜ) may be represented as a polynomial function (e.g., in Pᵢₙ), a piecewise linear function, or a sigmoid function.

In some examples, the input power (Pᵢₙ) may be computed for single-input-single-output (SISO) according to the following Equation 4:

$${P}_{i n} = {P}_{tx} {\vert {g}_{tx - r x} \vert}^{2} \qquad ( 4 )$$

where, |gₜₓ₋ᵣₓ|² may represent a channel matrix (e.g., a SISO channel matrix) between the transmitting device (e.g., the device 205-b) and the receiving device (e.g., the device 205-a). In some examples, |gₜₓ₋ᵣₓ|² may include (e.g., account for) both short-term fading and long-term fading. Additionally or alternatively, the input power (Pᵢₙ) may be computed for MIMO according to the following Equation 5:

$${P}_{i n} = T r \{ H Q P {Q}^{*} {H}^{*} \} \qquad ( 5 )$$

where, H may represent a MIMO channel matrix, Q may represent a precoder matrix, and P may represent a power allocation matrix. In some examples, the input power (Pᵢₙ) may be an example of the input power used to achieve a suitable (e.g., target) charging rate for the energy harvesting circuit 220 and the target charging rate may be an example of the output power (Pₒᵤₜ) of the energy harvesting circuit 220.

In some examples, the energy harvesting efficiency (n), and the capability of the energy harvesting circuit 220 to convert radio frequency energy to DC energy, may be a function of one or more pairings between the radio frequency band of the energy harvesting signals 235, the comb (e.g., comb structure, comb type) of the energy harvesting signals 235, the carrier frequency of the energy harvesting signals 235, and the bandwidth part of the energy harvesting signals 235. Additionally or alternatively, energy harvested by the device 205-a (e.g., or the amount of power consumed by the device 205-a performing energy harvesting) may depend on the frequency range of the bandwidth part or the type of communication link over which the signals are transmitted. For example, the device 205-a may perform one or more operations associated with energy harvesting, such as adjusting a bandwidth part or radio frequency circuit, performing frequency tunning, or operating a particular component carrier and a particular bandwidth part within the component carrier on a modem (e.g., a sidelink model or Uu link model), and performing such operations consumes an amount of power. In some examples, the power consumed performing such operations may be referred to as the cost of operating (e.g., the operating cost) on an active bandwidth part and a component carrier.

In some examples, as the number of component carriers in which the device is operating on increases, the operating cost is increases. For example, an operating cost function (e.g., or a number of maximum processes) may be defined. For instance, the operating cost of monitoring a bandwidth part within a single component carrier may be an amount (X), while the operating cost of monitoring a bandwidth part within two component carriers may be an increased amount (2X). In some examples, the operating cost of a sidelink circuit may be different from the operating cost of a Uu link circuit. For example, the operating cost of a sidelink circuit and a Uu link circuit may be described per component carrier (i) and bandwidth part (j) according to Equations 6 and 7, respectively:

$${X}_{SL}^{\{ i , j \}} \qquad ( 6 )$$

$${X}_{Uu}^{\{ i , j \}} . \qquad ( 7 )$$

In some examples, as the bandwidth of the bandwidth part increases, the operating cost may also increase. Additionally or alternatively, the operating cost may depend on the frequency range (e.g., FR1, FR2, FR2x, FR3, FR4, FR5, among others). In some examples, the component carriers used by the device 205-a for energy harvesting may be different than the component carriers used by the device 205-a for data (e.g., data transmission or data reception). For example, per link (e.g., per sidelink and per Uu link), an energy harvesting device (e.g., the device 205-a) may use a set (Yₓ) of component carriers for data and another set (Zₓ) of component carriers for energy harvesting, where x may correspond to the type of link used (e.g., x={PC5, Uu}). That is x may denote whether the set of component carriers correspond to component carriers used for sidelink communications or component carriers used for Uu link communications. The component carrier sets (e.g., Yₓ and Zₓ) may partially or fully overlap. For example, if the device 205-a is capable of power-splitting (e.g., performing energy harvesting via a power-splitting architecture) the device 205-a may harvest energy from data signals. Additionally or alternatively, if the device 205-a is capable of time-switching (e.g., performing energy harvesting via a time-switching architecture), the device 205-a may harvest energy from power, energy symbols, or slots transmitted from another device (e.g., the device 205-b).

In some examples, the operating cost (e.g., the cost of monitoring a relatively high number of component carriers or a relatively large bandwidth part of a component carrier) may become prohibitive for some devices, such as reduced capability devices or devices operating at a relatively low power, among other examples. Therefore, techniques which enable the selection of component carrier and bandwidth part pairs may reduce operating costs at an energy harvesting device (e.g., the device 205-a). For example, the device 205-a may receive a message indicating a configuration 230 for performing an energy harvesting procedure from the device 205-b via a communication link 245-b (e.g., a sidelink or a Uu link). The configuration 230 may indicate a pairing of a component carrier and a bandwidth part for the first device to use for performing the energy harvesting procedure. In some examples, the pairing may be based on one or more measurements associated with the device 205-a. For example, the paring may be determined to satisfy a performance metric based on the one or more measurements. As part of the energy harvesting procedure, the device 205-a may monitor for one or more signals from the device 205-b. For example, the device 205-a may monitor for the one or more energy harvesting signals 235 using a set of resources that correspond to the pairing of the component carrier and the bandwidth part. In some examples, the device 205-a may receive, from the device 205-b, one or more energy harvesting signals 235 using the set of resources, thereby reducing power costs at the device 205-a.

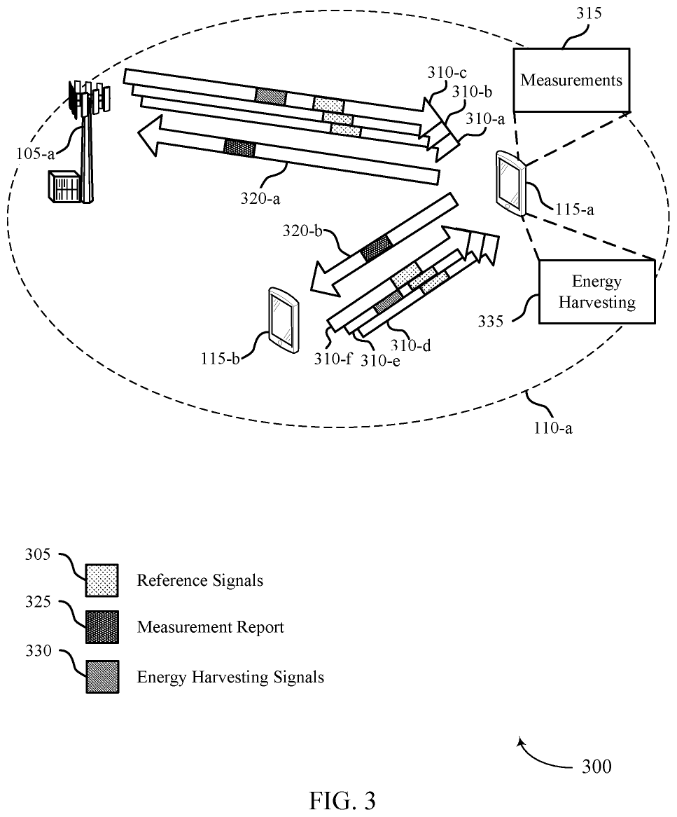

FIG. 3 illustrates an example of a wireless communications system 300 that supports energy harvesting for component carrier and bandwidth part pairings in accordance with aspects of the present disclosure. In some examples, the wireless communications system 300 may implement aspects of wireless communications system 100. For example, the wireless communications system 300 may include a base station 105-a and one or more UEs 115 (e.g., a UE 115-a and a UE 115-b) which may be examples of the corresponding devices described with reference to FIG. 1. The base station 105-a and the UEs 115 may communicate within a geographic coverage area 110-a and via one or more communication links (e.g., Uu links or sidelinks). The wireless communications systems 300 may include features for improved communications between the UEs 115 and the base station 105-a, among other benefits. In some examples of the wireless communications systems 300, the actions performed by the base station 105-a may be performed by other communication device, such as the UE 115 or IAB nodes (not shown). Additionally or alternatively, the actions performed by one or more UEs 115 may be performed by other communication device, such as the base station 105-a or the IAB nodes. In the example of FIG. 3, the UEs 115 may be examples of consumer premise equipments (CPEs) or IoTs.

As described herein, the UE 115-a may support wireless communications with the base station 105-a or another UE 115 (e.g., the UE 115-b) over a single component carrier or multiple component carriers. For example, the UE 115-a may communicate with the base station 105-a over a single component carrier 320-a or multiple component carriers 310 (e.g., a component carrier 310-a, a component carrier 310-b, and a component carrier 310-c). Additionally or alternatively, the UE 115-a may communicate with the UE 115-b over a single component carrier 320-b or multiple component carriers 310 (e.g., a component carrier 310-d, a component carrier 310-e, and a component carrier 310-f).

For example, the UE 115-a may transmit wireless communications to the base station 105-a or the UE 115-b in the wireless communications system 300 using a single component carrier 320 or multiple component carriers 310. Additionally or alternatively, the base station 105-a or the UE 115-b may transmit wireless communications to the UE 115-a using a single component carrier 320 or multiple component carriers 310. In some examples, the communications transmitted between the UE 115-a and the base station or the UE 115-a and the UE 115-b may be Uu link communications (e.g., communications over the Uu interface). Additionally or alternatively, the communications transmitted between the UE 115-a and the UE 115-b may be sidelink communications (e.g., communications over the PC5 interface).

The wireless communications system 300 may support various techniques for energy harvesting. For example, the UE 115-a may harvest energy from signals transmitted from the base station 105-a and the UE 115-b. In some examples of the wireless communications system 300, the base station 105-a may power the UE 115-a via Uu link component carriers. Additionally or alternatively, the UE 115-a may power another UE 115 (e.g., an IoT device), such as the UE 115-b or another UE 115 (not shown) via Uu link component carriers (e.g., if the UEs 115 use a same component carrier or multiple of the same component carriers).

In some examples, the UE 115-a may consume (e.g., spend, expend) energy monitoring for signals to perform energy harvesting. For example, the energy expended by the UE 115-a monitoring a bandwidth part (j) of a component carrier (i) on sidelinks and Uu links for signals may be described according to Equation 8:

$${X}_{SL}^{\{ i , j \}} + {X}_{Uu}^{\{ i , j \}} \qquad ( 8 )$$

In some examples, if the UE 115-a is to harvest energy from a particular component carrier and bandwidth part pair ({i, j}), the UE 115-a may harvest a particular amount of energy based on characteristics of the channel (e.g., measured CSI).

In some examples, the UE 115-a may report capabilities of the UE 115-a to harvest energy or operate as an energy harvesting device to other devices (e.g., the base station 105-a and the UE 115-b), such as other devices that may provide energy harvesting signals to the UE 115-a. In some examples, the reported energy harvesting capabilities may include information associated with the energy harvesting circuits at the UE 115-a. For example, the capability information may indicate how efficiently the energy harvesting circuits at the UE 115-a may operate at particular frequency bands or particular component carriers or how efficiently the energy harvesting circuit may combine more than one frequency band, component carrier, or bandwidth part.

In some examples, to increase energy performance at the UE 115-a (e.g., an IoT device or a wearable device), a transmitting device (e.g., the base station 105-a or the UE 115-b) may select a component carrier and bandwidth part pair to use for energy harvesting based on energy costs (e.g., power consumption) associated with monitoring particular component carrier and bandwidth part pairs at the UE 115-a. In some examples, the transmitting device may select a component carrier and bandwidth part pair for transmitting signals to be used for energy harvesting (e.g., energy harvesting signals) at the UE 115-a based on measurements performed at the transmitting device or based on measurements performed at the UE 115-a and reported to the transmitting device. For example, if the base station 105-a powers (e.g., energizes) the UE 115-a (e.g., if the transmitting device is the base station 105-a), the base station 105-a may select a component carrier and bandwidth part pair based on measurements of a charging rate, CSI, or one or more statistics, among other examples.

For example, the base station 105-a may transmit reference signals 305 via multiple component carriers 310 (e.g., the component carrier 310-a, the component carrier 310-b, and the component carrier 310-c) and the respective bandwidth part, not shown. That is, each of the multiple component carriers 310 may be associated with a respective bandwidth part and each reference signal 305 may be transmitted via a component carrier and bandwidth part pair. The UE 115-a may perform one or more measurements 315 on the reference signals 305. The UE 115-a may report the one or more measurements to the base station 105-a, for example in a measurement report 325. The base station 105-a may select a component carrier 310-a (e.g., and the respective bandwidth part) based on the one or more measurements 315. The base station 105-a may transmit one or more signals (e.g., one or more energy harvesting signals 330) via the selected component carrier 310-a to the UE 115-a for energy harvesting 335.

In some examples, the measurements 315 may include instantaneous measurements from multiple (e.g., different) active component carriers on active bandwidth parts. For example, the UE 115-a may transmit a report (e.g., to the base station 105-a) regarding instantaneous charging rate measurements performed at the UE 115-a. That is, the UE 115-a may use the measured instantaneous charging rate (e.g., a measured charge over time) as a reporting quantity. Additionally or alternatively, the UE 115-a (e.g., the power receiving UE) may report CSI measurements performed at the UE 115-a. In some examples, the CSI report may be based on reference signal received power (RSRP) measurements, reference signal received quality (RSRQ) measurements, received signal strength indicator measurements, or any combination thereof, performed on demodulation reference signals (DMRSs) or CSI reference signals (CSI-RSs). That is, the CSI report may be a DMRS based report or a CSI-RS based report.

In some examples, the base station 105-a may determine (e.g., compute) the charging rate based reference signals (e.g., sounding reference signals (SRSs)) transmitted from the UE 115-a (e.g., the power-receiving UE). The reference signals may have a relatively low density or may be configured for use by the base station 105-a in computing the charging rate (e.g., potential charging rate) or channel quality of particular component carrier and bandwidth part pairs. In some examples, while such a determination may be aided by the UE 115-a, the determination may be transparent to the UE 115-a.

Additionally or alternatively, the measurements 315 may include an average of multiple measurements from multiple (e.g., different) component carriers across bandwidth parts (e.g., active bandwidth parts or inactive bandwidth parts). For example, the UE 115-a may report (e.g., to the base station 105-a) an average charging rate across measurements performed on multiple transmissions using multiple component carrier and bandwidth part pairs (e.g., multiple transmissions measured per component carrier and bandwidth part pair). That is, the UE 115-a may use the average charging rate as a reporting quantity. In some examples, the average charging rate may be determined from measurements performed over a duration (e.g., a defined duration or window for computing the average). Additionally or alternatively, the UE 115-a may report average statistics to the base station 105-a. That is, the UE 115-a (e.g., the power-receiving UE) may use average statistics (e.g., associated with each component carrier and bandwidth part pair) as a reporting quantity.

In some examples, the base station 105-a may determine the average CSI based on a history of transmissions from the UE 115-a. For example, the base station 105-a may determine whether a particular component carrier and bandwidth part pair may be suitable (e.g., compared to other component carrier and bandwidth part pairs) by accumulating acknowledgement (e.g., or negative acknowledgement) messages transmitted from the UE 115-a over the multiple component carrier and bandwidth part pairs. In some examples, if the base station 105-a accumulates an increased number of acknowledgement messages for a first component carrier and bandwidth part pair compared to other component carrier and bandwidth part pairs, the base station 105-a may select the first component carrier and bandwidth part pair for transmitting energy harvesting signals to the UE 115-a. Additionally or alternatively, if the base station 105-a accumulates an increased number of negative acknowledgement messages for the first component carrier and bandwidth part pair compared to other component carrier and bandwidth part pairs, the base station 105-a may refrain from selecting the first component carrier and bandwidth part pair for transmitting energy harvesting signals to the UE 115-a. As such, the base station 105-a may use the accumulation of acknowledgement or negative acknowledgement messages as a metric to determine a suitable component carrier and bandwidth part pair for energy harvesting at the UE 115-a.

In some examples, the base station 105-a may determine (e.g., measure) the average statistics based on signals transmitted from the UE 115-a. For example, the base station 105-a may measure statistics for each component carrier and bandwidth part pair used by the UE 115-a to transmit physical uplink control channel (PUCCH) transmissions or physical uplink shared channel (PUSCH) transmissions. In some examples, the base station 105-a may determine average statistics for each component carrier and bandwidth part pair used by the UE 115-a to transmit reference signals (e.g., SRSs).

In some examples, if the UE 115-b powers (e.g., energizes) the UE 115-a (e.g., if the UE 115-b is the transmitting device), the UE 115-b may select a component carrier (e.g., a Uu link component carrier or a sidelink component carrier) and one or more bandwidth parts (e.g., one or more component carrier and bandwidth part pairs) based on measurements of a charging rate, CSI, or one or more statistics, among other examples. For example, the UE 115-b may transmit reference signals 305 via multiple component carriers 310 (e.g., the component carrier 310-d, the component carrier 310-e, and the component carrier 310-f) and the respective bandwidth part, not shown. The UE 115-a may perform one or more measurements 315 on the reference signals 305. The UE 115-a may report the one or more measurements to the UE 115-b, for example in a measurement report 325. The UE 115-b may select a component carrier 310-e (e.g., and the respective bandwidth part) based on the one or more measurements 315. The UE 115-b may transmit one or more signals (e.g., one or more energy harvesting signals 330) via the selected component carrier 310-e to the UE 115-a for energy harvesting 335.

In some example, the component carriers may be Uu link component carriers. In such examples, the measurements 315 may include instantaneous measurements from multiple (e.g., different) active component carriers (e.g., Uu component carriers) on active bandwidth parts. For example, the UE 115-a may transmit a report (e.g., to the UE 115-b) regarding instantaneous charging rate measurements performed at the UE 115-a. Additionally or alternatively, the UE 115-a may report instantaneous CSI measurements performed at the UE 115-a. In some examples, the reported CSI may be based on crosslink interference, in which the UE 115-b or another device (e.g., the base station 105-a) may configure channel state information interference measurement (CSI-IM) resources for the UE 115-a (e.g., the power receiving UE) to determine (e.g., compute) the CSI. In some examples, the UE 115-a may be configured via a sidelink to perform communications (e.g., to receive energy harvesting signals) via a Uu link. That is, the UE 115-b may configure the UE 115-a via a sidelink and transmit energy harvesting signals to the UE 115-a via a Uu link.

In some examples, the UE 115-b may determine the instantaneous CSI based on reference signals (e.g., SRSs) transmitted from the UE 115-a. For example, the UE 115-a may transmit reference signals (e.g., on multiple component carrier and bandwidth part pairs) to the UE 115-b and the UE 115-b may measure crosslink interference (e.g., of the transmitted reference signals) and determine the CSI (e.g., for each of the multiple component carrier bandwidth part pairs) based on the crosslink interference measurements.

Additionally or alternatively, the measurements 315 may include an average of multiple measurements from multiple (e.g., different) component carriers across bandwidth parts (e.g., active bandwidth parts or inactive bandwidth parts). For example, the UE 115-a may report average statistics to the UE 115-b. In some examples, the average statistics may be determined by the UE 115-a based on measurements (e.g., CSI-IM) performed on resources configured by the UE 115-b or the base station 105-a. That is, the CSI-IM resources used to perform the measurements from which the CSI is determined may be configured for the UE 115-a (e.g., by the UE 115-b or the base station 1-5-a). In some examples, the average statistics may be measured at the UE 115-b. For example, the UE 115-b may measure the average statistics from reference signals (e.g., SRSs) transmitted from the UE 115-a. In some examples, the UE 115-a may transmit reference signals (e.g., on multiple component carrier and bandwidth part pairs) to the UE 115-b and the UE 115-b may measure crosslink interference (e.g., of the transmitted reference signals) and determine the average statistics (e.g., for each of the multiple component carrier bandwidth part pairs) based on the crosslink interference measurements. The UE 115-b may be configured to perform the crosslink interference measurements by the UE 115-a or another device (e.g., the base station 105-a).

In other examples, the component carriers may be sidelink component carriers. In such examples, the measurements 315 may include instantaneous measurements from multiple (e.g., different) active component carriers (e.g., sidelink component carriers) on active bandwidth parts. For example, the UE 115-a may transmit a report (e.g., to the UE 115-b) regarding instantaneous charging rate measurements performed at the UE 115-a. Additionally or alternatively, the UE 115-a may report instantaneous CSI measurements performed at the UE 115-a. In some examples, the reported CSI may be based on measurements of reference signals (e.g., DMRSs or CSI-RSs) transmitted from the UE 115-b (e.g., via a sidelink). In some examples, the UE 115-b may determine the instantaneous CSI based on reference signals (e.g., SRSs) transmitted from the UE 115-a. For example, the UE 115-a may transmit reference signals (e.g., on multiple component carrier and bandwidth part pairs) to the UE 115-b and the UE 115-b may determine the CSI (e.g., for each of the multiple component carrier bandwidth part pairs) based on measurements performed at the UE 115-b.

Additionally or alternatively, the measurements 315 may include an average of multiple measurements from multiple (e.g., different) component carriers across bandwidth parts (e.g., active bandwidth parts or inactive bandwidth parts). In some examples, the average statistics may be based on measurements (e.g., RSRP measurements, RSRQ measurements, or RSSI measurements) performed on signals, such as reference signals (e.g., DMRS or SRSs) or signals transmitted via the physical sidelink shared channel (PSSCH). In some examples, the average statistics may be measured at the UE 115-a (e.g., based on signals transmitted from the UE 115-b) or at the UE 115-b (e.g., based on signals transmitted from the UE 115-a.

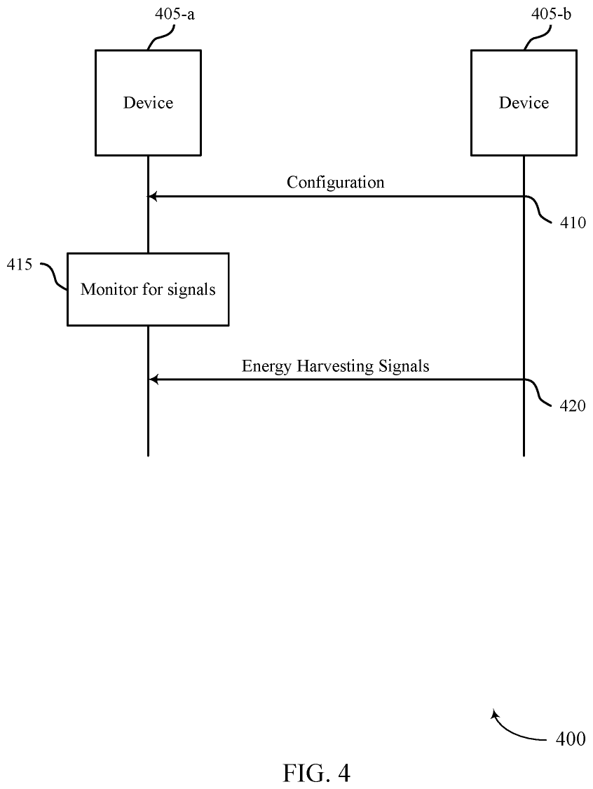

FIG. 4 illustrates an example of a process flow 400 that supports energy harvesting for component carrier and bandwidth part pairings in accordance with aspects of the present disclosure. The process flow 400 may implement or be implemented by one or more aspects of the wireless communications systems 100, 200, and 300. For example, the process flow 400 may include one or more devices 405 (e.g., a device 405-a and a device 405-b), which may be examples of a base station 105 or a UE 115 as discussed with reference to FIGS. 1 through 3. In some examples, the devices 405 may also be IAB nodes. In the example of FIG. 4, the device 405-b may be a transmitting device and the device 405-a may be a receiving device. In the following description of the process flow 400, operations between the device 405-a and the device 405-b may occur in a different order or at different times than as shown. Some operations may also be omitted from the process flow 400, and other operations may be added to the process flow 400.

At 410, the device 405-b may transmit a message to the device 405-a indicating a configuration for performing an energy harvesting procedure by the device 405-b. The configuration may indicate a pairing of a component carrier and a bandwidth part for the device 405-a to use for performing the energy harvesting procedure. The component carrier and a bandwidth part pairing may be selected based on one or more measurements (e.g., and satisfying a performance criterion) associated with the device 405-a. The one or more measurements may be examples of measurements 315 described with reference to FIG. 3. For example, the measurements may include charging rate measurements, CSI measurements, or one or more statistics, among other examples. In some examples, the indicated component carrier and bandwidth part pairing may be selected by the device 405-a. For example, the device 405-a may report a set (e.g., a recommended set) of component carrier and bandwidth part pairs (e.g., including component carrier and bandwidth part pairs for both Uu links and sidelink) to the device 405-b. In some examples, the device 405-a may report the set of component carrier and bandwidth part pairs based on an operating cost (e.g., energy expenditure) of using each component carrier and bandwidth part pair or based on measured CSI (e.g., instantaneous CSI or average CSI). In such examples, the device 405-b (e.g., or another device 405, not shown) may configure the device 405-a with resources for determining the CSI, for example due to a request for transmitting energy harvesting signals to the device 405-a.

In some examples, the device 405-b may be a UE. In such examples, the device 405-a may consider a power headroom (PHR) of the device 405-b (e.g., the powering device). That is, the selected component carrier and bandwidth part pair may be based on the PHR (e.g., an amount of available transmit power) of the device 405-b. For example, the device 405-b may indicate (e.g., signal) the PHR of the device 405-b to the device 405-a (e.g., an IoT device) and the device 405-a may select the component carrier and bandwidth part pair based on the indicated PHR. In some examples, the device 405-b may indicate the PHR to the device 405-a periodically (e.g., or prior to the device 405-a selecting the component carrier and bandwidth part pair).

In some examples, the set of component carrier and bandwidth part pairs reported by the device 405-a may include a list of parameters for each component carrier and bandwidth part pair. For example, the list may include a link type (e.g., sidelink or Uu link) and an identifier of the component carrier and bandwidth part pair (e.g., {i, j}). In some examples, the list size may be configured via signaling (e.g., radio resource control (RRC) signaling, medium access control control element (MAC-CE) signaling, downlink control information (DCI) signaling, or sidelink control information (SCI) signaling) from another device (e.g., the device 405-b or another device 405, not shown). In some examples, the list may be reported to the device 405-b or another device 405, not shown. For example, the device 405-a may report the list to a base station 105, the power charging device (e.g., the device 405-b), or both, to aid in configuring the component carrier and bandwidth part pairs. As such, the device 405-a may increase efficiencies associated with signal (e.g., data) decoding and energy harvesting.

In some examples, the CSI (e.g., the instantaneous CSI or the average CSI) may be determined (e.g., computed) at a device (e.g., a terminal) different from the device 405-a. However, because the operating cost may be measured and known at the device 405-a, the CSI may be indicated (e.g., signaled) to the device 405-a from the device determining the CSI. The device 405-a may use the indicated CSI and the determined operating costs to determine a suitable subset of component carrier and bandwidth part pairs to be used for energy harvesting. Additionally or alternatively, the device 405-a may determine whether to combine multiple component carrier and bandwidth part pairs (e.g., based on operating costs of each component carrier and bandwidth part pair) or to use a single component carrier and bandwidth part pair for energy harvesting.

In other examples, the indicated component carrier and bandwidth part pairing may be selected by the device 405-b. For example, the operating costs associated with particular component carrier and bandwidth part pairs may be relative to a determined (e.g., defined, preconfigured, or configured) component carrier and bandwidth part pair operating cost that may be indicated (e.g., signaled) to the device 405-a from the device 405-b (e.g., or another device 405, not shown). For example, the device 405-b may be a UE, and in such an example, the device 405-b may select the indicated component carrier and bandwidth part pairing based on the PHR of the device 405-b. In some examples, another device 405 (e.g., a base station, a programmable logic controller, or a relay UE, not shown) may control the device 405-a (e.g., for some sidelink operations). In such examples, the other device 405 may report the PHR of the other device 405 to the device selecting the component carrier and bandwidth part pairing (e.g., the device 405-b or the device 405-a).

In some examples, the CSI (e.g., the average CSI or the instantaneous CSI) may be reported (e.g., signaled, relayed) to the device selecting the component carrier and bandwidth part pairing. The resources for determining the instantaneous CSI and the average CSI may be configured based on a request for transmitting energy harvesting signals to the device 405-a. In some examples, operating costs may be known to the device 405-b through reference signals (e.g., SRS) transmitted from the device 405-a and, as such, may be used for selecting the component carrier and bandwidth part pairing (e.g., without statistics, CSI reports, or charging rate reports).

In some examples, the set of component carrier and bandwidth part pairs reported by the device 405-a may include a list of parameters for each component carrier and bandwidth part pair. For example, the list may include a link type (e.g., sidelink or Uu link) and an identifier of the component carrier and bandwidth part pair (e.g., {i, j}). In some examples, the list size may be configured via signaling (e.g., RRC signaling, MAC-CE signaling, DCI signaling, or SCI signaling) from another device. For example, the list size may be configured by the device 405-b or another device 405 (e.g., a device controlling the device 405-a, not shown). In some examples, the list may be reported to the device 405-b or another device 405, not shown. For example, the device 405-a may report the list to the device controlling the device 405-a (e.g., a base station, not shown), the power charging device (e.g., the transmitting device, the device 405-b), or both, to aid in configuring the component carrier and bandwidth part pairs for energy harvesting and signal (e.g., data) decoding or for joint purposes (e.g., for performing power-splitting or time-switching).

At 415, the device 405-a may monitor for one or more signals from a second device as part of the energy harvesting procedure. For example, the device 405-a may monitor for one or more signals using a set of resources that correspond to the pairing of the component carrier and the bandwidth part. At 420, the device 405-a may receive energy harvesting signals from the device 405-b. The energy harvesting signals may be transmitted using a set of resources that correspond to the pairing of the component carrier and the bandwidth part. As such, the device 405-a may reduce operating costs associated with energy harvesting, among other benefits.

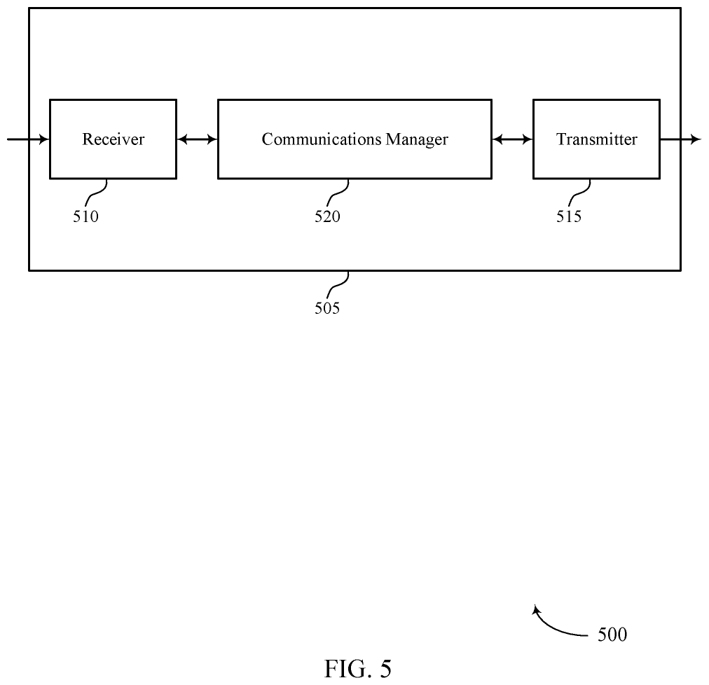

FIG. 5 shows a block diagram 500 of a device 505 that supports energy harvesting for component carrier and bandwidth part pairings in accordance with aspects of the present disclosure. The device 505 may be an example of aspects of a UE 115, a base station 105, or an IAB node as described herein. The device 505 may include a receiver 510, a transmitter 515, and a communications manager 520. The device 505 may also include a processor. Each of these components may be in communication with one another (e.g., via one or more buses).

The receiver 510 may provide a means for receiving information such as packets, user data, control information, or any combination thereof associated with various information channels (e.g., control channels, data channels, information channels related to energy harvesting for component carrier and bandwidth part pairings). Information may be passed on to other components of the device 505. The receiver 510 may utilize a single antenna or a set of multiple antennas.

The transmitter 515 may provide a means for transmitting signals generated by other components of the device 505. For example, the transmitter 515 may transmit information such as packets, user data, control information, or any combination thereof associated with various information channels (e.g., control channels, data channels, information channels related to energy harvesting for component carrier and bandwidth part pairings). In some examples, the transmitter 515 may be co-located with a receiver 510 in a transceiver module. The transmitter 515 may utilize a single antenna or a set of multiple antennas.

The communications manager 520, the receiver 510, the transmitter 515, or various combinations thereof or various components thereof may be examples of means for performing various aspects of energy harvesting for component carrier and bandwidth part pairings as described herein. For example, the communications manager 520, the receiver 510, the transmitter 515, or various combinations or components thereof may support a method for performing one or more of the functions described herein.

In some examples, the communications manager 520, the receiver 510, the transmitter 515, or various combinations or components thereof may be implemented in hardware (e.g., in communications management circuitry). The hardware may include a processor, a digital signal processor (DSP), an application-specific integrated circuit (ASIC), a field-programmable gate array (FPGA) or other programmable logic device, a discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally or alternatively, in some examples, the communications manager 520, the receiver 510, the transmitter 515, or various combinations or components thereof may be implemented in code (e.g., as communications management software or firmware) executed by a processor. If implemented in code executed by a processor, the functions of the communications manager 520, the receiver 510, the transmitter 515, or various combinations or components thereof may be performed by a general-purpose processor, a DSP, a central processing unit (CPU), an ASIC, an FPGA, or any combination of these or other programmable logic devices (e.g., configured as or otherwise supporting a means for performing the functions described in the present disclosure).

In some examples, the communications manager 520 may be configured to perform various operations (e.g., receiving, monitoring, transmitting) using or otherwise in cooperation with the receiver 510, the transmitter 515, or both. For example, the communications manager 520 may receive information from the receiver 510, send information to the transmitter 515, or be integrated in combination with the receiver 510, the transmitter 515, or both to receive information, transmit information, or perform various other operations as described herein.

The communications manager 520 may support wireless communication at a first device (e.g., the device 505) in accordance with examples as disclosed herein. For example, the communications manager 520 may be configured as or otherwise support a means for receiving a message indicating a configuration for performing an energy harvesting procedure by the first device, the configuration indicating a pairing of a component carrier and a bandwidth part for the first device to use for performing the energy harvesting procedure, the pairing based on one or more measurements associated with the first device. The communications manager 520 may be configured as or otherwise support a means for monitoring, as part of the energy harvesting procedure, for one or more signals from a second device (e.g., another device 505) using a set of resources that correspond to the pairing of the component carrier and the bandwidth part.

By including or configuring the communications manager 520 in accordance with examples as described herein, the device 505 (e.g., a processor controlling or otherwise coupled with the receiver 510, the transmitter 515, the communications manager 520, or a combination thereof) may support techniques for reduced power consumption, increased energy harvested from signals, and improved battery life.

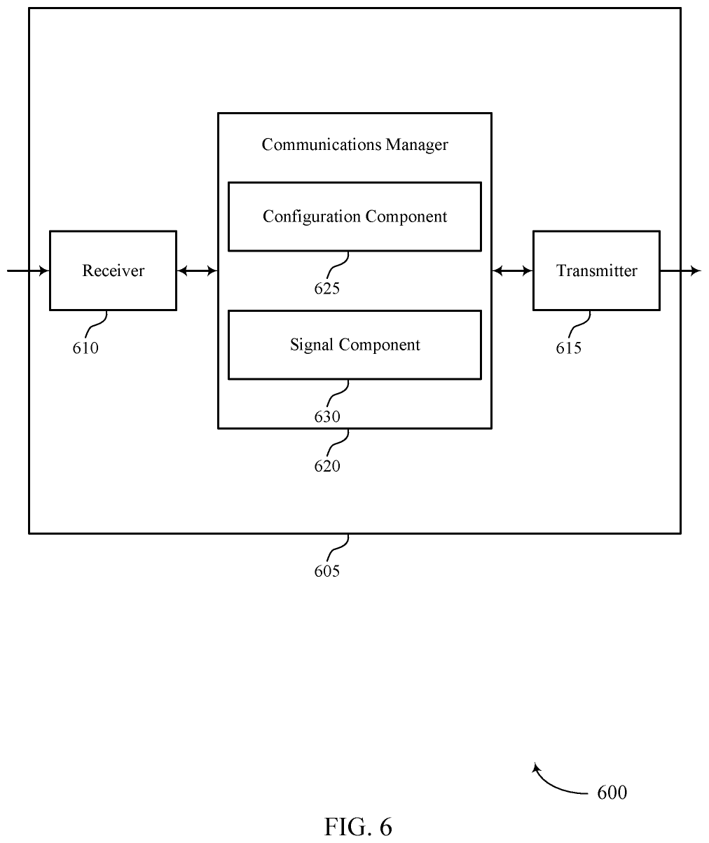

FIG. 6 shows a block diagram 600 of a device 605 that supports energy harvesting for component carrier and bandwidth part pairings in accordance with aspects of the present disclosure. The device 605 may be an example of aspects of a device 505, a UE 115, a base station 105, or an IAB node as described herein. The device 605 may include a receiver 610, a transmitter 615, and a communications manager 620. The device 605 may also include a processor. Each of these components may be in communication with one another (e.g., via one or more buses).

The receiver 610 may provide a means for receiving information such as packets, user data, control information, or any combination thereof associated with various information channels (e.g., control channels, data channels, information channels related to energy harvesting for component carrier and bandwidth part pairings). Information may be passed on to other components of the device 605. The receiver 610 may utilize a single antenna or a set of multiple antennas.

The transmitter 615 may provide a means for transmitting signals generated by other components of the device 605. For example, the transmitter 615 may transmit information such as packets, user data, control information, or any combination thereof associated with various information channels (e.g., control channels, data channels, information channels related to energy harvesting for component carrier and bandwidth part pairings). In some examples, the transmitter 615 may be co-located with a receiver 610 in a transceiver module. The transmitter 615 may utilize a single antenna or a set of multiple antennas.

The device 605, or various components thereof, may be an example of means for performing various aspects of energy harvesting for component carrier and bandwidth part pairings as described herein. For example, the communications manager 620 may include a configuration component 625 a signal component 630, or any combination thereof. The communications manager 620 may be an example of aspects of a communications manager 520 as described herein. In some examples, the communications manager 620, or various components thereof, may be configured to perform various operations (e.g., receiving, monitoring, transmitting) using or otherwise in cooperation with the receiver 610, the transmitter 615, or both. For example, the communications manager 620 may receive information from the receiver 610, send information to the transmitter 615, or be integrated in combination with the receiver 610, the transmitter 615, or both to receive information, transmit information, or perform various other operations as described herein.

The communications manager 620 may support wireless communication at a first device (e.g., the device 605) in accordance with examples as disclosed herein. The configuration component 625 may be configured as or otherwise support a means for receiving a message indicating a configuration for performing an energy harvesting procedure by the first device, the configuration indicating a pairing of a component carrier and a bandwidth part for the first device to use for performing the energy harvesting procedure, the pairing based on one or more measurements associated with the first device. The signal component 630 may be configured as or otherwise support a means for monitoring, as part of the energy harvesting procedure, for one or more signals from a second device (e.g., another device 605) using a set of resources that correspond to the pairing of the component carrier and the bandwidth part.

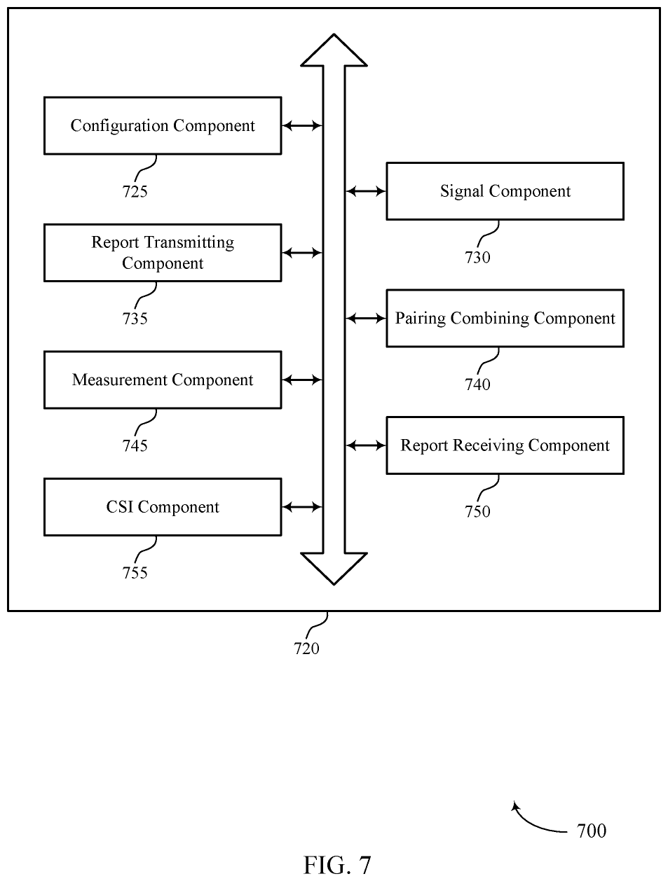

FIG. 7 shows a block diagram 700 of a communications manager 720 that supports energy harvesting for component carrier and bandwidth part pairings in accordance with aspects of the present disclosure. The communications manager 720 may be an example of aspects of a communications manager 520, a communications manager 620, or both, as described herein. The communications manager 720, or various components thereof, may be an example of means for performing various aspects of energy harvesting for component carrier and bandwidth part pairings as described herein. For example, the communications manager 720 may include a configuration component 725, a signal component 730, a report transmitting component 735, a pairing combining component 740, a measurement component 745, a report receiving component 750, a CSI component 755, or any combination thereof. Each of these components may communicate, directly or indirectly, with one another (e.g., via one or more buses).

The communications manager 720 may support wireless communication at a first device (e.g., a UE, a base station, or an IAB node) in accordance with examples as disclosed herein. The configuration component 725 may be configured as or otherwise support a means for receiving a message indicating a configuration for performing an energy harvesting procedure by the first device, the configuration indicating a pairing of a component carrier and a bandwidth part for the first device to use for performing the energy harvesting procedure, the pairing based on one or more measurements associated with the first device. The signal component 730 may be configured as or otherwise support a means for monitoring, as part of the energy harvesting procedure, for one or more signals from a second device (e.g., another UE, another base station, or another IAB node) using a set of resources that correspond to the pairing of the component carrier and the bandwidth part.

In some examples, the report transmitting component 735 may be configured as or otherwise support a means for transmitting, to the second device, a report indicating a second pairing of a second component carrier and a second bandwidth part that satisfies a performance criterion based on the one or more measurements associated with the first device. In some examples, the report receiving component 750 may be configured as or otherwise support a means for receiving a PHR report from the second device, where transmitting the report is based on the PHR report.

In some examples, the report transmitting component 735 may be configured as or otherwise support a means for transmitting the report including one or more communication link types and one or more pairings of a respective component carrier and a respective bandwidth part, where each of the one or more pairings corresponds to a respective communication link type of the one or more communication link types. In some examples, the measurement component 745 may be configured as or otherwise support a means for receiving an indication of the one or more measurements from the second device, where transmitting the report is based on the one or more measurements.

In some examples, the pairing combining component 740 may be configured as or otherwise support a means for combining two or more pairings of respective component carriers and respective bandwidth parts, where the set of resources corresponds to the combined two or more pairings of the respective component carriers and the respective bandwidth parts. In some examples, the report transmitting component 735 may be configured as or otherwise support a means for transmitting, to the second device, a PHR report indicating a transmit power availability of the first device, where the configuration for performing the energy harvesting procedure is based on the transmit power availability of the first device.

In some examples, the signal component 730 may be configured as or otherwise support a means for receiving one or more reference signals using one or more sets of resources, each of the one or more sets of resources corresponding to a respective pairing of a respective bandwidth part and a respective component carrier. In some examples, the measurement component 745 may be configured as or otherwise support a means for performing measurements based on the one or more reference signals to obtain the one or more measurements associated with the first device.

In some examples, the CSI component 755 may be configured as or otherwise support a means for transmitting CSI for one or more pairings of respective component carriers and bandwidth parts based on performing the measurements. In some examples, to support performing the measurements, the measurement component 745 may be configured as or otherwise support a means for measuring an energy expenditure associated with each respective pairing.

In some examples, to support performing the measurements, the measurement component 745 may be configured as or otherwise support a means for measuring a current CSI corresponding to each respective pairing. In some examples, to support performing the measurements, the measurement component 745 may be configured as or otherwise support a means for measuring an average CSI corresponding to each respective pairing.

In some examples, to support measuring the average CSI, the measurement component 745 may be configured as or otherwise support a means for measuring an accumulation of acknowledgement or negative acknowledgement information corresponding to each pairing, an average charging rate across multiple transmissions measured for each pairing, an average statistic received from another device, or a combination thereof.

In some examples, the report transmitting component 735 may be configured as or otherwise support a means for transmitting a measurement report indicating the measurements of the one or more reference signals, where receiving the message indicating the configuration for performing the energy harvesting procedure is based on transmitting the measurement report. In some examples, to support receiving the message indicating the configuration for performing the energy harvesting procedure, the configuration component 725 may be configured as or otherwise support a means for receiving the message from the second device, or a third device different from the second device and the first device.

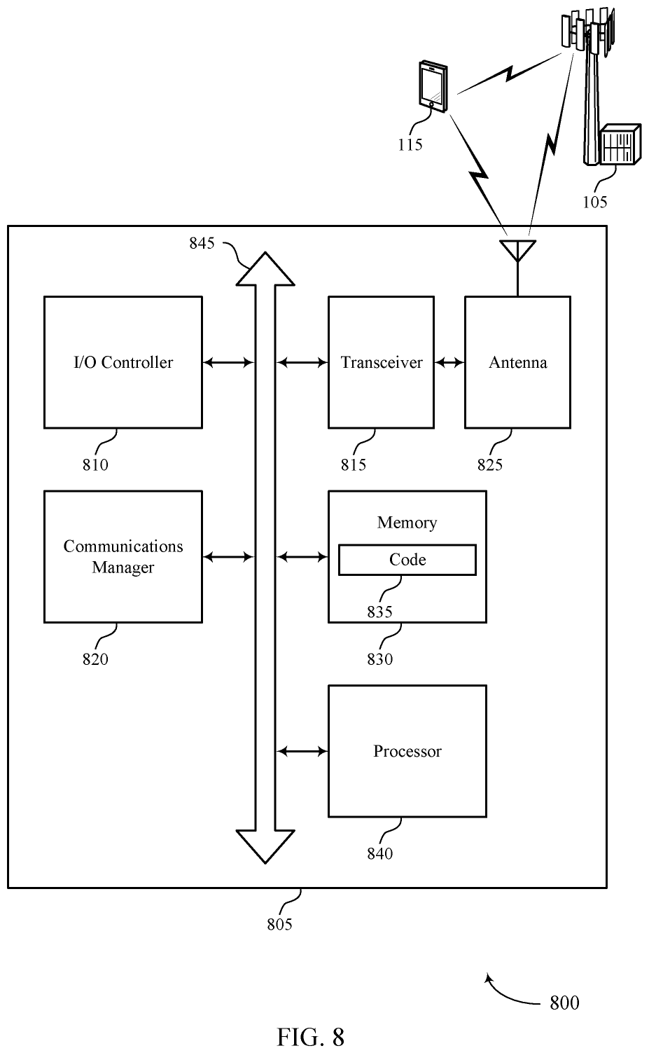

FIG. 8 shows a diagram of a system 800 including a device 805 that supports energy harvesting for component carrier and bandwidth part pairings in accordance with aspects of the present disclosure. The device 805 may be an example of or include the components of a device 505, a device 605, a UE 115, a base station 105, or an IAB node as described herein. The device 805 may communicate wirelessly with one or more base stations 105, UEs 115, or any combination thereof. The device 805 may include components for bi-directional voice and data communications including components for transmitting and receiving communications, such as a communications manager 820, an input/output (I/O) controller 810, a transceiver 815, an antenna 825, a memory 830, code 835, and a processor 840. These components may be in electronic communication or otherwise coupled (e.g., operatively, communicatively, functionally, electronically, electrically) via one or more buses (e.g., a bus 845).

The I/O controller 810 may manage input and output signals for the device 805. The I/O controller 810 may also manage peripherals not integrated into the device 805. In some cases, the I/O controller 810 may represent a physical connection or port to an external peripheral. In some cases, the I/O controller 810 may utilize an operating system such as iOS®, ANDROID®, MS-DOS®, MS-WINDOWS®, OS/2®, UNIX®, LINUX®, or another known operating system. Additionally or alternatively, the I/O controller 810 may represent or interact with a modem, a keyboard, a mouse, a touchscreen, or a similar device. In some cases, the I/O controller 810 may be implemented as part of a processor, such as the processor 840. In some cases, a user may interact with the device 805 via the I/O controller 810 or via hardware components controlled by the I/O controller 810.

In some cases, the device 805 may include a single antenna 825. However, in some other cases, the device 805 may have more than one antenna 825, which may be capable of concurrently transmitting or receiving multiple wireless transmissions. The transceiver 815 may communicate bi-directionally, via the one or more antennas 825, wired, or wireless links as described herein. For example, the transceiver 815 may represent a wireless transceiver and may communicate bi-directionally with another wireless transceiver. The transceiver 815 may also include a modem to modulate the packets, to provide the modulated packets to one or more antennas 825 for transmission, and to demodulate packets received from the one or more antennas 825. The transceiver 815, or the transceiver 815 and one or more antennas 825, may be an example of a transmitter 515, a transmitter 615, a receiver 510, a receiver 610, or any combination thereof or component thereof, as described herein.

The memory 830 may include random access memory (RAM) and read-only memory (ROM). The memory 830 may store computer-readable, computer-executable code 835 including instructions that, when executed by the processor 840, cause the device 805 to perform various functions described herein. The code 835 may be stored in a non-transitory computer-readable medium such as system memory or another type of memory. In some cases, the code 835 may not be directly executable by the processor 840 but may cause a computer (e.g., when compiled and executed) to perform functions described herein. In some cases, the memory 830 may contain, among other things, a basic I/O system (BIOS) which may control basic hardware or software operation such as the interaction with peripheral components or devices.

The processor 840 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 840 may be configured to operate a memory array using a memory controller. In some other cases, a memory controller may be integrated into the processor 840. The processor 840 may be configured to execute computer-readable instructions stored in a memory (e.g., the memory 830) to cause the device 805 to perform various functions (e.g., functions or tasks supporting energy harvesting for component carrier and bandwidth part pairings). For example, the device 805 or a component of the device 805 may include a processor 840 and memory 830 coupled with or to the processor 840, the processor 840 and memory 830 configured to perform various functions described herein.

The communications manager 820 may support wireless communication at a first device (e.g., the device 805) in accordance with examples as disclosed herein. For example, the communications manager 820 may be configured as or otherwise support a means for receiving a message indicating a configuration for performing an energy harvesting procedure by the first device, the configuration indicating a pairing of a component carrier and a bandwidth part for the first device to use for performing the energy harvesting procedure, the pairing based on one or more measurements associated with the first device. The communications manager 820 may be configured as or otherwise support a means for monitoring, as part of the energy harvesting procedure, for one or more signals from a second device using a set of resources that correspond to the pairing of the component carrier and the bandwidth part.

By including or configuring the communications manager 820 in accordance with examples as described herein, the device 805 may support techniques for reduced power consumption, more efficient utilization of communication resources, increased energy harvested from signals, improved coordination between devices, longer battery life, and improved utilization of processing capability.

In some examples, the communications manager 820 may be configured to perform various operations (e.g., receiving, monitoring, transmitting) using or otherwise in cooperation with the transceiver 815, the one or more antennas 825, or any combination thereof. Although the communications manager 820 is illustrated as a separate component, in some examples, one or more functions described with reference to the communications manager 820 may be supported by or performed by the processor 840, the memory 830, the code 835, or any combination thereof. For example, the code 835 may include instructions executable by the processor 840 to cause the device 805 to perform various aspects of energy harvesting for component carrier and bandwidth part pairings as described herein, or the processor 840 and the memory 830 may be otherwise configured to perform or support such operations.

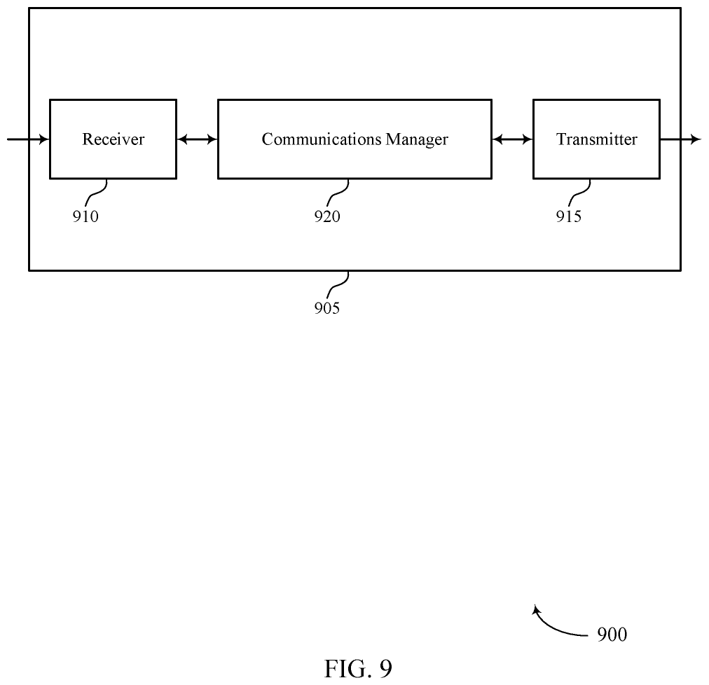

FIG. 9 shows a block diagram 900 of a device 905 that supports energy harvesting for component carrier and bandwidth part pairings in accordance with aspects of the present disclosure. The device 905 may be an example of aspects of a base station 105, a UE 115, or an IAB node as described herein. The device 905 may include a receiver 910, a transmitter 915, and a communications manager 920. The device 905 may also include a processor. Each of these components may be in communication with one another (e.g., via one or more buses).

The receiver 910 may provide a means for receiving information such as packets, user data, control information, or any combination thereof associated with various information channels (e.g., control channels, data channels, information channels related to energy harvesting for component carrier and bandwidth part pairings). Information may be passed on to other components of the device 905. The receiver 910 may utilize a single antenna or a set of multiple antennas.

The transmitter 915 may provide a means for transmitting signals generated by other components of the device 905. For example, the transmitter 915 may transmit information such as packets, user data, control information, or any combination thereof associated with various information channels (e.g., control channels, data channels, information channels related to energy harvesting for component carrier and bandwidth part pairings). In some examples, the transmitter 915 may be co-located with a receiver 910 in a transceiver module. The transmitter 915 may utilize a single antenna or a set of multiple antennas.

The communications manager 920, the receiver 910, the transmitter 915, or various combinations thereof or various components thereof may be examples of means for performing various aspects of energy harvesting for component carrier and bandwidth part pairings as described herein. For example, the communications manager 920, the receiver 910, the transmitter 915, or various combinations or components thereof may support a method for performing one or more of the functions described herein.

In some examples, the communications manager 920, the receiver 910, the transmitter 915, or various combinations or components thereof may be implemented in hardware (e.g., in communications management circuitry). The hardware may include a processor, a DSP, an ASIC, an FPGA or other programmable logic device, a discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally or alternatively, in some examples, the communications manager 920, the receiver 910, the transmitter 915, or various combinations or components thereof may be implemented in code (e.g., as communications management software or firmware) executed by a processor. If implemented in code executed by a processor, the functions of the communications manager 920, the receiver 910, the transmitter 915, or various combinations or components thereof may be performed by a general-purpose processor, a DSP, a CPU, an ASIC, an FPGA, or any combination of these or other programmable logic devices (e.g., configured as or otherwise supporting a means for performing the functions described in the present disclosure).

In some examples, the communications manager 920 may be configured to perform various operations (e.g., receiving, monitoring, transmitting) using or otherwise in cooperation with the receiver 910, the transmitter 915, or both. For example, the communications manager 920 may receive information from the receiver 910, send information to the transmitter 915, or be integrated in combination with the receiver 910, the transmitter 915, or both to receive information, transmit information, or perform various other operations as described herein.

The communications manager 920 may support wireless communication at a first device (e.g., the device 905) in accordance with examples as disclosed herein. For example, the communications manager 920 may be configured as or otherwise support a means for transmitting a message indicating a configuration for performing an energy harvesting procedure by a second device (e.g., another device 905), the configuration indicating a pairing of a component carrier and a bandwidth part for the second device to use for performing the energy harvesting procedure, the pairing based on one or more measurements associated with the second device. The communications manager 920 may be configured as or otherwise support a means for transmitting, as part of the energy harvesting procedure, one or more signals to the second device using a set of resources that correspond to the pairing of the component carrier and the bandwidth part.

By including or configuring the communications manager 920 in accordance with examples as described herein, the device 905 (e.g., a processor controlling or otherwise coupled with the receiver 910, the transmitter 915, the communications manager 920, or a combination thereof) may support techniques for reduced power consumption, increased energy harvested from signals, and improved battery life.

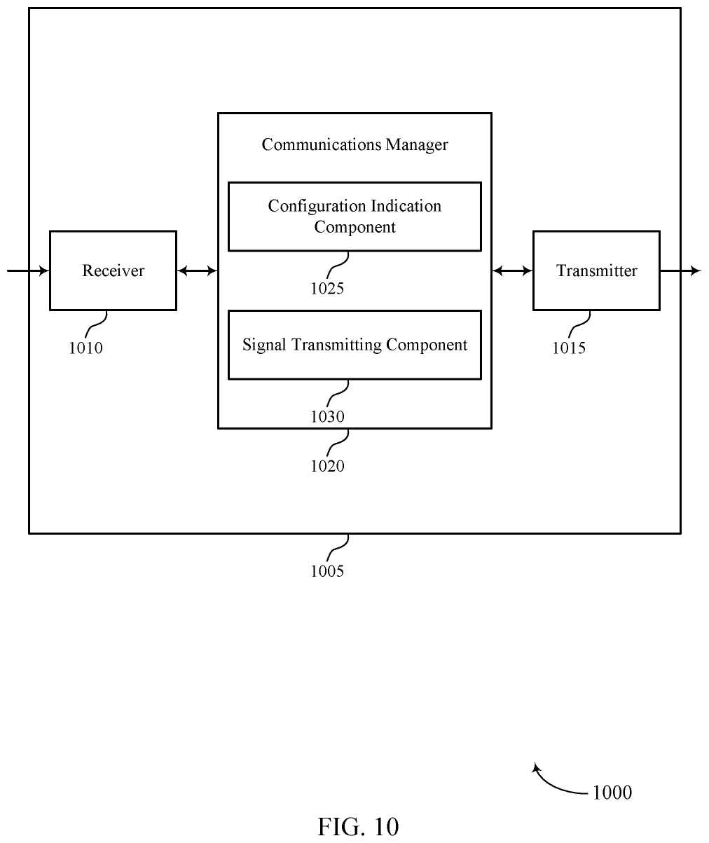

FIG. 10 shows a block diagram 1000 of a device 1005 that supports energy harvesting for component carrier and bandwidth part pairings in accordance with aspects of the present disclosure. The device 1005 may be an example of aspects of a device 905, a base station 105, a UE 115, or an IAB node as described herein. The device 1005 may include a receiver 1010, a transmitter 1015, and a communications manager 1020. The device 1005 may also include a processor. Each of these components may be in communication with one another (e.g., via one or more buses).

The receiver 1010 may provide a means for receiving information such as packets, user data, control information, or any combination thereof associated with various information channels (e.g., control channels, data channels, information channels related to energy harvesting for component carrier and bandwidth part pairings). Information may be passed on to other components of the device 1005. The receiver 1010 may utilize a single antenna or a set of multiple antennas.

The transmitter 1015 may provide a means for transmitting signals generated by other components of the device 1005. For example, the transmitter 1015 may transmit information such as packets, user data, control information, or any combination thereof associated with various information channels (e.g., control channels, data channels, information channels related to energy harvesting for component carrier and bandwidth part pairings). In some examples, the transmitter 1015 may be co-located with a receiver 1010 in a transceiver module. The transmitter 1015 may utilize a single antenna or a set of multiple antennas.

The device 1005, or various components thereof, may be an example of means for performing various aspects of energy harvesting for component carrier and bandwidth part pairings as described herein. For example, the communications manager 1020 may include a configuration indication component 1025 a signal transmitting component 1030, or any combination thereof. The communications manager 1020 may be an example of aspects of a communications manager 920 as described herein. In some examples, the communications manager 1020, or various components thereof, may be configured to perform various operations (e.g., receiving, monitoring, transmitting) using or otherwise in cooperation with the receiver 1010, the transmitter 1015, or both. For example, the communications manager 1020 may receive information from the receiver 1010, send information to the transmitter 1015, or be integrated in combination with the receiver 1010, the transmitter 1015, or both to receive information, transmit information, or perform various other operations as described herein.

The communications manager 1020 may support wireless communication at a first device (e.g., the device 1005) in accordance with examples as disclosed herein. The configuration indication component 1025 may be configured as or otherwise support a means for transmitting a message indicating a configuration for performing an energy harvesting procedure by a second device (e.g., another device 1005), the configuration indicating a pairing of a component carrier and a bandwidth part for the second device to use for performing the energy harvesting procedure, the pairing based on one or more measurements associated with the second device. The signal transmitting component 1030 may be configured as or otherwise support a means for transmitting, as part of the energy harvesting procedure, one or more signals to the second device using a set of resources that correspond to the pairing of the component carrier and the bandwidth part.

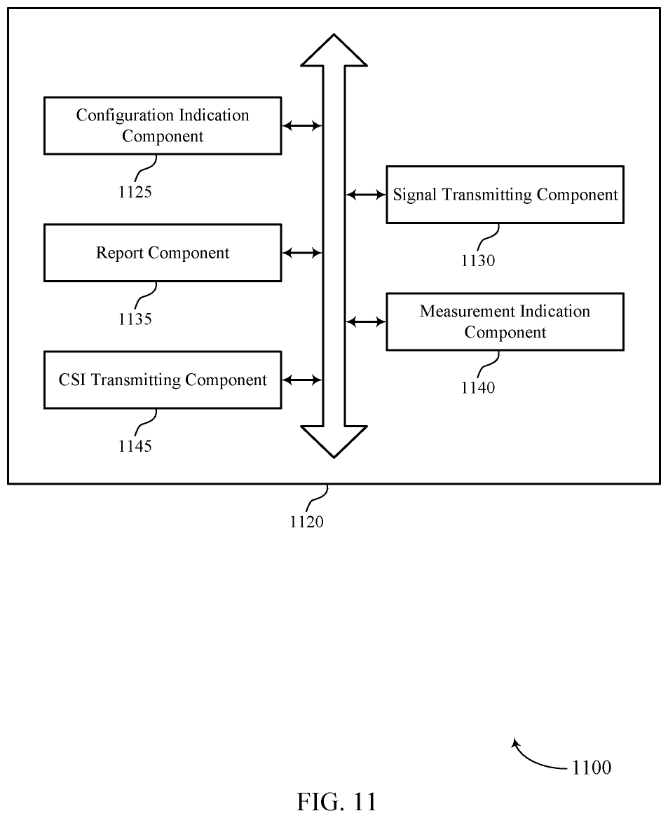

FIG. 11 shows a block diagram 1100 of a communications manager 1120 that supports energy harvesting for component carrier and bandwidth part pairings in accordance with aspects of the present disclosure. The communications manager 1120 may be an example of aspects of a communications manager 920, a communications manager 1020, or both, as described herein. The communications manager 1120, or various components thereof, may be an example of means for performing various aspects of energy harvesting for component carrier and bandwidth part pairings as described herein. For example, the communications manager 1120 may include a configuration indication component 1125, a signal transmitting component 1130, a report component 1135, a measurement indication component 1140, a CSI transmitting component 1145, or any combination thereof. Each of these components may communicate, directly or indirectly, with one another (e.g., via one or more buses).

The communications manager 1120 may support wireless communication at a first device (e.g., a base station, a UE, or an IAB node) in accordance with examples as disclosed herein. The configuration indication component 1125 may be configured as or otherwise support a means for transmitting a message indicating a configuration for performing an energy harvesting procedure by a second device (e.g., another base station, another UE, or another IAB node), the configuration indicating a pairing of a component carrier and a bandwidth part for the second device to use for performing the energy harvesting procedure, the pairing based on one or more measurements associated with the second device. The signal transmitting component 1130 may be configured as or otherwise support a means for transmitting, as part of the energy harvesting procedure, one or more signals to the second device using a set of resources that correspond to the pairing of the component carrier and the bandwidth part.

In some examples, the report component 1135 may be configured as or otherwise support a means for receiving, from the second device, a report indicating a second pairing of a second component carrier and a second bandwidth part that satisfies a performance criterion based on the one or more measurements associated with the second device. In some examples, the report component 1135 may be configured as or otherwise support a means for transmitting a PHR report to the second device, where receiving the report is based on the PHR report.

In some examples, the report component 1135 may be configured as or otherwise support a means for receiving the report including one or more communication link types and one or more pairings of a respective component carrier and a respective bandwidth part, where each of the one or more pairings corresponds to a respective communication link type of the one or more communication link types. In some examples, the measurement indication component 1140 may be configured as or otherwise support a means for transmitting an indication of the one or more measurements to the second device, where receiving the report is based on the one or more measurements.

In some examples, the report component 1135 may be configured as or otherwise support a means for receiving, from the second device, a PHR report indicating a transmit power availability of the first device, where the configuration for performing the energy harvesting procedure is based on the transmit power availability of the first device.

In some examples, the signal transmitting component 1130 may be configured as or otherwise support a means for transmitting one or more reference signals using one or more sets of resources, each of the one or more sets of resources corresponding to a respective pairing of a respective bandwidth part and a respective component carrier. In some examples, the measurement indication component 1140 may be configured as or otherwise support a means for performing measurements based on the one or more reference signals to obtain the one or more measurements associated with the second device.

In some examples, the CSI transmitting component 1145 may be configured as or otherwise support a means for transmitting CSI for one or more pairings of respective component carriers and bandwidth parts based on performing the measurements. In some examples, to support performing the measurements, the measurement indication component 1140 may be configured as or otherwise support a means for measuring an energy expenditure associated with each respective pairing.

In some examples, to support performing the measurements, the measurement indication component 1140 may be configured as or otherwise support a means for measuring a current CSI corresponding to each respective pairing. In some examples, to support performing the measurements, the measurement indication component 1140 may be configured as or otherwise support a means for measuring an average CSI corresponding to each respective pairing.

In some examples, to support measuring the CSI, the measurement indication component 1140 may be configured as or otherwise support a means for measuring an accumulation of acknowledgement or negative acknowledgement information corresponding to each pairing, an average charging rate across multiple transmissions measured for each pairing, an average statistic received from another device, or a combination thereof.

In some examples, the report component 1135 may be configured as or otherwise support a means for receiving a measurement report indicating the measurements of the one or more reference signals, where transmitting the message indicating the configuration for performing the energy harvesting procedure is based on receiving the measurement report. In some examples, to support transmitting the message indicating the configuration for performing the energy harvesting procedure, the configuration indication component 1125 may be configured as or otherwise support a means for transmitting the message from the second device, or a third device different from the second device and the first device.

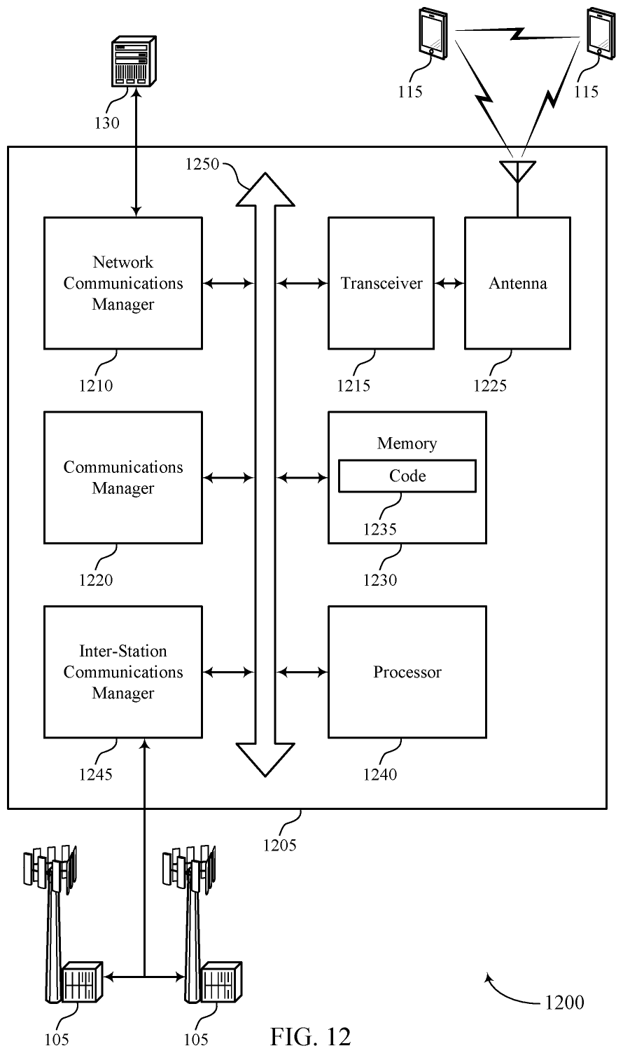

FIG. 12 shows a diagram of a system 1200 including a device 1205 that supports energy harvesting for component carrier and bandwidth part pairings in accordance with aspects of the present disclosure. The device 1205 may be an example of or include the components of a device 905, a device 1005, a base station 105, a UE 115, or an IAB node as described herein. The device 1205 may communicate wirelessly with one or more base stations 105, UEs 115, or any combination thereof. The device 1205 may include components for bi-directional voice and data communications including components for transmitting and receiving communications, such as a communications manager 1220, a network communications manager 1210, a transceiver 1215, an antenna 1225, a memory 1230, code 1235, a processor 1240, and an inter-station communications manager 1245. These components may be in electronic communication or otherwise coupled (e.g., operatively, communicatively, functionally, electronically, electrically) via one or more buses (e.g., a bus 1250).

The network communications manager 1210 may manage communications with a core network 130 (e.g., via one or more wired backhaul links). For example, the network communications manager 1210 may manage the transfer of data communications for client devices, such as one or more UEs 115.

In some cases, the device 1205 may include a single antenna 1225. However, in some other cases the device 1205 may have more than one antenna 1225, which may be capable of concurrently transmitting or receiving multiple wireless transmissions. The transceiver 1215 may communicate bi-directionally, via the one or more antennas 1225, wired, or wireless links as described herein. For example, the transceiver 1215 may represent a wireless transceiver and may communicate bi-directionally with another wireless transceiver. The transceiver 1215 may also include a modem to modulate the packets, to provide the modulated packets to one or more antennas 1225 for transmission, and to demodulate packets received from the one or more antennas 1225. The transceiver 1215, or the transceiver 1215 and one or more antennas 1225, may be an example of a transmitter 915, a transmitter 1015, a receiver 910, a receiver 1010, or any combination thereof or component thereof, as described herein.

The memory 1230 may include RAM and ROM. The memory 1230 may store computer-readable, computer-executable code 1235 including instructions that, when executed by the processor 1240, cause the device 1205 to perform various functions described herein. The code 1235 may be stored in a non-transitory computer-readable medium such as system memory or another type of memory. In some cases, the code 1235 may not be directly executable by the processor 1240 but may cause a computer (e.g., when compiled and executed) to perform functions described herein. In some cases, the memory 1230 may contain, among other things, a BIOS which may control basic hardware or software operation such as the interaction with peripheral components or devices.

The processor 1240 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 1240 may be configured to operate a memory array using a memory controller. In some other cases, a memory controller may be integrated into the processor 1240. The processor 1240 may be configured to execute computer-readable instructions stored in a memory (e.g., the memory 1230) to cause the device 1205 to perform various functions (e.g., functions or tasks supporting energy harvesting for component carrier and bandwidth part pairings). For example, the device 1205 or a component of the device 1205 may include a processor 1240 and memory 1230 coupled with or to the processor 1240, the processor 1240 and memory 1230 configured to perform various functions described herein.

The inter-station communications manager 1245 may manage communications with other base stations 105, and may include a controller or scheduler for controlling communications with UEs 115 in cooperation with other base stations 105. For example, the inter-station communications manager 1245 may coordinate scheduling for transmissions to UEs 115 for various interference mitigation techniques such as beamforming or joint transmission. In some examples, the inter-station communications manager 1245 may provide an X2 interface within an LTE/LTE-A wireless communications network technology to provide communication between base stations 105.

The communications manager 1220 may support wireless communication at a first device (e.g., the device 1205) in accordance with examples as disclosed herein. For example, the communications manager 1220 may be configured as or otherwise support a means for transmitting a message indicating a configuration for performing an energy harvesting procedure by a second device, the configuration indicating a pairing of a component carrier and a bandwidth part for the second device to use for performing the energy harvesting procedure, the pairing based on one or more measurements associated with the second device. The communications manager 1220 may be configured as or otherwise support a means for transmitting, as part of the energy harvesting procedure, one or more signals to the second device using a set of resources that correspond to the pairing of the component carrier and the bandwidth part.

By including or configuring the communications manager 1220 in accordance with examples as described herein, the device 1205 may support techniques for reduced power consumption, increased energy harvested from signals, more efficient utilization of communication resources, improved coordination between devices, longer battery life, and improved utilization of processing capability.

In some examples, the communications manager 1220 may be configured to perform various operations (e.g., receiving, monitoring, transmitting) using or otherwise in cooperation with the transceiver 1215, the one or more antennas 1225, or any combination thereof. Although the communications manager 1220 is illustrated as a separate component, in some examples, one or more functions described with reference to the communications manager 1220 may be supported by or performed by the processor 1240, the memory 1230, the code 1235, or any combination thereof. For example, the code 1235 may include instructions executable by the processor 1240 to cause the device 1205 to perform various aspects of energy harvesting for component carrier and bandwidth part pairings as described herein, or the processor 1240 and the memory 1230 may be otherwise configured to perform or support such operations.

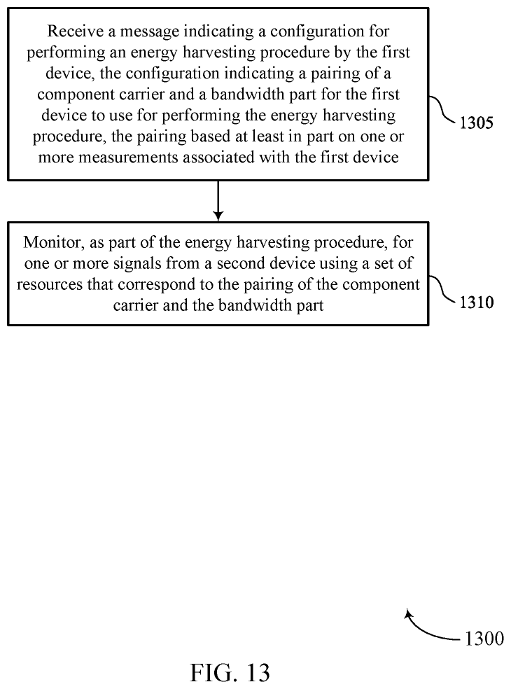

FIG. 13 shows a flowchart illustrating a method 1300 that supports energy harvesting for component carrier and bandwidth part pairings in accordance with aspects of the present disclosure. The operations of the method 1300 may be implemented by a UE, a base station, an IAB node or components of the UE, the base station, or the IAB node as described herein. For example, the operations of the method 1300 may be performed by a UE 115, a base station 105, or an IAB node as described with reference to FIGS. 1 through 8. In some examples, a UE, a base station, or an IAB node may execute a set of instructions to control the functional elements of the UE, the base station, or the IAB node to perform the described functions. Additionally or alternatively, the UE, the base station, or the IAB node may perform aspects of the described functions using special-purpose hardware.

At 1305, the method may include receiving a message indicating a configuration for performing an energy harvesting procedure by the first device (e.g., a UE, a base station, or an IAB node), the configuration indicating a pairing of a component carrier and a bandwidth part for the first device to use for performing the energy harvesting procedure, the pairing based on one or more measurements associated with the first device. The operations of 1305 may be performed in accordance with examples as disclosed herein. In some examples, aspects of the operations of 1305 may be performed by a configuration component 725 as described with reference to FIG. 7.

At 1310, the method may include monitoring, as part of the energy harvesting procedure, for one or more signals from a second device (e.g., another UE, another base station, or another IAB node) using a set of resources that correspond to the pairing of the component carrier and the bandwidth part. The operations of 1310 may be performed in accordance with examples as disclosed herein. In some examples, aspects of the operations of 1310 may be performed by a signal component 730 as described with reference to FIG. 7.

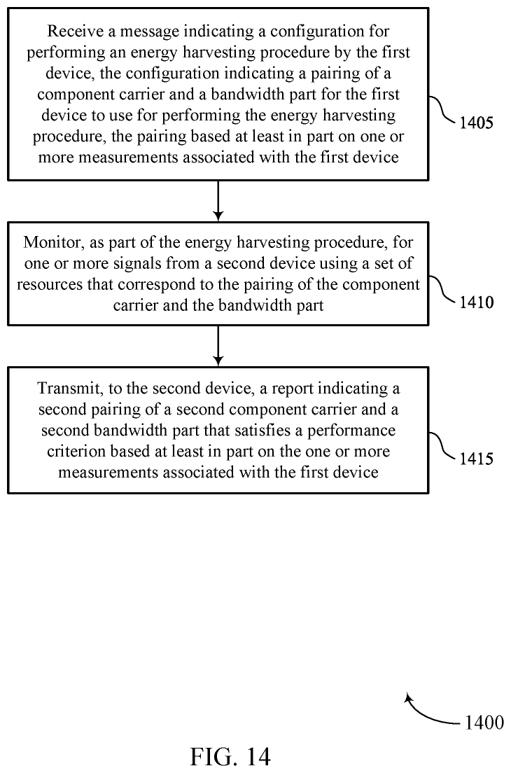

FIG. 14 shows a flowchart illustrating a method 1400 that supports energy harvesting for component carrier and bandwidth part pairings in accordance with aspects of the present disclosure. The operations of the method 1400 may be implemented by a UE, a base station, an IAB node or components of the UE, the base station, or the IAB node as described herein. For example, the operations of the method 1400 may be performed by a UE 115, a base station 105, or an IAB node as described with reference to FIGS. 1 through 8. In some examples, a UE, a base station, or an IAB node may execute a set of instructions to control the functional elements of the UE, the base station, or the IAB node to perform the described functions. Additionally or alternatively, the UE, the base station, or the IAB node may perform aspects of the described functions using special-purpose hardware.

At 1405, the method may include receiving a message indicating a configuration for performing an energy harvesting procedure by the first device (e.g., a UE, a base station, or an IAB node), the configuration indicating a pairing of a component carrier and a bandwidth part for the first device to use for performing the energy harvesting procedure, the pairing based on one or more measurements associated with the first device. The operations of 1405 may be performed in accordance with examples as disclosed herein. In some examples, aspects of the operations of 1405 may be performed by a configuration component 725 as described with reference to FIG. 7.

At 1410, the method may include monitoring, as part of the energy harvesting procedure, for one or more signals from a second device (e.g., another UE, another base station, or another IAB node) using a set of resources that correspond to the pairing of the component carrier and the bandwidth part. The operations of 1410 may be performed in accordance with examples as disclosed herein. In some examples, aspects of the operations of 1410 may be performed by a signal component 730 as described with reference to FIG. 7.

At 1415, the method may include transmitting, to the second device, a report indicating a second pairing of a second component carrier and a second bandwidth part that satisfies a performance criterion based on the one or more measurements associated with the first device. The operations of 1415 may be performed in accordance with examples as disclosed herein. In some examples, aspects of the operations of 1415 may be performed by a report transmitting component 735 as described with reference to FIG. 7.

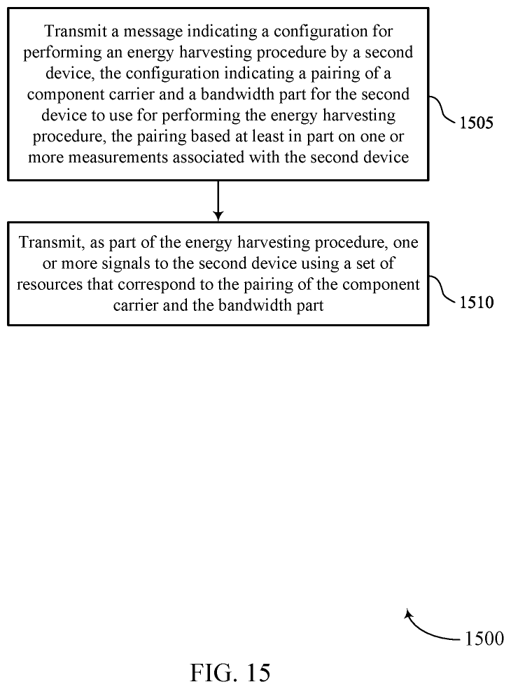

FIG. 15 shows a flowchart illustrating a method 1500 that supports energy harvesting for component carrier and bandwidth part pairings in accordance with aspects of the present disclosure. The operations of the method 1500 may be implemented by a base station, a UE, an IAB node or components of the base station, the UE, or the IAB node as described herein. For example, the operations of the method 1500 may be performed by a base station 105, a UE 115, or an IAB node as described with reference to FIGS. 1 through 4 and 9 through 12. In some examples, a base station, a UE, or an IAB node may execute a set of instructions to control the functional elements of the base station, the UE, or the IAB node to perform the described functions. Additionally or alternatively, the base station, the UE, or the IAB node may perform aspects of the described functions using special-purpose hardware.

At 1505, the method may include transmitting a message indicating a configuration for performing an energy harvesting procedure by a second device (e.g., a base station, a UE, or an IAB node), the configuration indicating a pairing of a component carrier and a bandwidth part for the second device to use for performing the energy harvesting procedure, the pairing based on one or more measurements associated with the second device. The operations of 1505 may be performed in accordance with examples as disclosed herein. In some examples, aspects of the operations of 1505 may be performed by a configuration indication component 1125 as described with reference to FIG. 11.

At 1510, the method may include transmitting, as part of the energy harvesting procedure, one or more signals to the second device using a set of resources that correspond to the pairing of the component carrier and the bandwidth part. The operations of 1510 may be performed in accordance with examples as disclosed herein. In some examples, aspects of the operations of 1510 may be performed by a signal transmitting component 1130 as described with reference to FIG. 11.

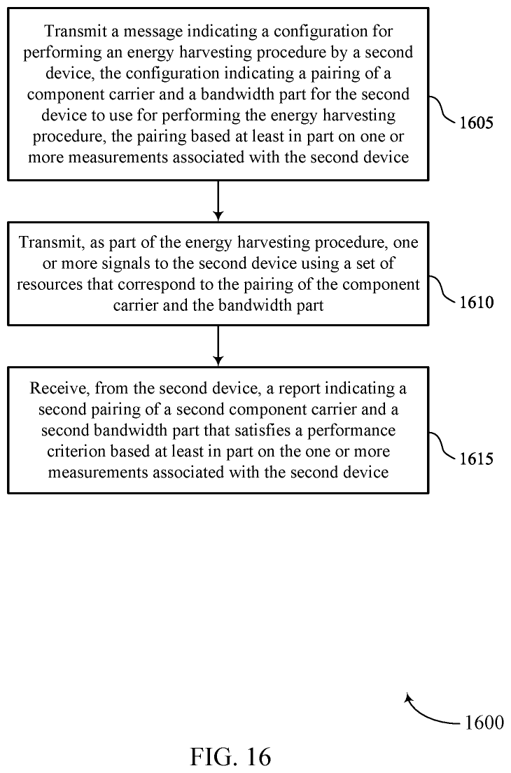

FIG. 16 shows a flowchart illustrating a method 1600 that supports energy harvesting for component carrier and bandwidth part pairings in accordance with aspects of the present disclosure. The operations of the method 1600 may be implemented by a base station, a UE, or an IAB node or the components of the base station, the UE, or the IAB node as described herein. For example, the operations of the method 1600 may be performed by a base station 105, a UE 115, or an IAB node as described with reference to FIGS. 1 through 4 and 9 through 12. In some examples, a base station, a UE, or an IAB node may execute a set of instructions to control the functional elements of the base station, the UE, or the IAB node to perform the described functions. Additionally or alternatively, the base station, the UE, or the IAB node may perform aspects of the described functions using special-purpose hardware.

At 1605, the method may include transmitting a message indicating a configuration for performing an energy harvesting procedure by a second device (e.g., a base station, a UE, or an IAB node), the configuration indicating a pairing of a component carrier and a bandwidth part for the second device to use for performing the energy harvesting procedure, the pairing based on one or more measurements associated with the second device. The operations of 1605 may be performed in accordance with examples as disclosed herein. In some examples, aspects of the operations of 1605 may be performed by a configuration indication component 1125 as described with reference to FIG. 11.

At 1610, the method may include transmitting, as part of the energy harvesting procedure, one or more signals to the second device using a set of resources that correspond to the pairing of the component carrier and the bandwidth part. The operations of 1610 may be performed in accordance with examples as disclosed herein. In some examples, aspects of the operations of 1610 may be performed by a signal transmitting component 1130 as described with reference to FIG. 11.

At 1615, the method may include receiving, from the second device, a report indicating a second pairing of a second component carrier and a second bandwidth part that satisfies a performance criterion based on the one or more measurements associated with the second device. The operations of 1615 may be performed in accordance with examples as disclosed herein. In some examples, aspects of the operations of 1615 may be performed by a report component 1135 as described with reference to FIG. 11.

The following provides an overview of aspects of the present disclosure:

Aspect 1: A method for wireless communication at a first device, comprising: receiving a message indicating a configuration for performing an energy harvesting procedure by the first device, the configuration indicating a pairing of a component carrier and a bandwidth part for the first device to use for performing the energy harvesting procedure, the pairing based at least in part on one or more measurements associated with the first device; and monitoring, as part of the energy harvesting procedure, for one or more signals from a second device using a set of resources that correspond to the pairing of the component carrier and the bandwidth part.

Aspect 2: The method of aspect 1, further comprising: transmitting, to the second device, a report indicating a second pairing of a second component carrier and a second bandwidth part that satisfies a performance criterion based at least in part on the one or more measurements associated with the first device.

Aspect 3: The method of aspect 2, further comprising: receiving a power headroom report from the second device, wherein transmitting the report is based at least in part on the power headroom report.

Aspect 4: The method of any of aspects 2 through 3, further comprising: transmitting the report including one or more communication link types and one or more pairings of a respective component carrier and a respective bandwidth part, wherein each of the one or more pairings corresponds to a respective communication link type of the one or more communication link types.

Aspect 5: The method of any of aspects 2 through 4, further comprising: receiving an indication of the one or more measurements from the second device, wherein transmitting the report is based at least in part on the one or more measurements.

Aspect 6: The method of any of aspects 1 through 5, further comprising: combining two or more pairings of respective component carriers and respective bandwidth parts, wherein the set of resources corresponds to the combined two or more pairings of the respective component carriers and the respective bandwidth parts.

Aspect 7: The method of any of aspects 1 through 6, further comprising: transmitting, to the second device, a power headroom report indicating a transmit power availability of the first device, wherein the configuration for performing the energy harvesting procedure is based at least in part on the transmit power availability of the first device.

Aspect 8: The method of any of aspects 1 through 7, further comprising: receiving one or more reference signals using one or more sets of resources, each of the one or more sets of resources corresponding to a respective pairing of a respective bandwidth part and a respective component carrier; and performing measurements based at least in part on the one or more reference signals to obtain the one or more measurements associated with the first device.

Aspect 9: The method of aspect 8, further comprising: transmitting channel state information for one or more pairings of respective component carriers and bandwidth parts based at least in part on performing the measurements.

Aspect 10: The method of any of aspects 8 through 9, wherein performing the measurements comprises: measuring an energy expenditure associated with each respective pairing.

Aspect 11: The method of any of aspects 8 through 9, wherein performing the measurements comprises: measuring a current channel state information corresponding to each respective pairing.

Aspect 12: The method of any of aspects 8 through 9, wherein performing the measurements comprises: measuring an average channel state information corresponding to each respective pairing.

Aspect 13: The method of aspect 12, wherein measuring the average channel state information comprises: measuring an accumulation of acknowledgement or negative acknowledgement information corresponding to each pairing, an average charging rate across multiple transmissions measured for each pairing, an average statistic received from another device, or a combination thereof.

Aspect 14: The method of any of aspects 8 through 13, further comprising: transmitting a measurement report indicating the measurements of the one or more reference signals, wherein receiving the message indicating the configuration for performing the energy harvesting procedure is based at least in part on transmitting the measurement report.

Aspect 15: The method of any of aspects 1 through 14, further comprising: receiving, from the second device and using the set of resources that correspond to the pairing of the component carrier and the bandwidth part, at least one signal of the one or more signals, the at least one signal comprising a data signal; decoding, the at least one signal based at least in part on the at least one signal comprising the data signal; and performing the energy harvesting procedure to convert at least a portion of the at least one signal to power to be used at the first device.

Aspect 16: The method of any of aspects 1 through 15, wherein receiving the message indicating the configuration for performing the energy harvesting procedure comprises: receiving the message from the second device, or a third device different from the second device and the first device.

Aspect 17: A method for wireless communication at a first device, comprising: transmitting a message indicating a configuration for performing an energy harvesting procedure by a second device, the configuration indicating a pairing of a component carrier and a bandwidth part for the second device to use for performing the energy harvesting procedure, the pairing based at least in part on one or more measurements associated with the second device; and transmitting, as part of the energy harvesting procedure, one or more signals to the second device using a set of resources that correspond to the pairing of the component carrier and the bandwidth part.

Aspect 18: The method of aspect 17, further comprising: receiving, from the second device, a report indicating a second pairing of a second component carrier and a second bandwidth part that satisfies a performance criterion based at least in part on the one or more measurements associated with the second device.

Aspect 19: The method of aspect 18, further comprising: transmitting a power headroom report to the second device, wherein receiving the report is based at least in part on the power headroom report.

Aspect 20: The method of any of aspects 18 through 19, further comprising: receiving the report including one or more communication link types and one or more pairings of a respective component carrier and a respective bandwidth part, wherein each of the one or more pairings corresponds to a respective communication link type of the one or more communication link types.

Aspect 21: The method of any of aspects 18 through 20, further comprising: transmitting an indication of the one or more measurements to the second device, wherein receiving the report is based at least in part on the one or more measurements.

Aspect 22: The method of any of aspects 17 through 21, further comprising: receiving, from the second device, a power headroom report indicating a transmit power availability of the first device, wherein the configuration for performing the energy harvesting procedure is based at least in part on the transmit power availability of the first device.

Aspect 23: The method of any of aspects 17 through 22, further comprising: transmitting one or more reference signals using one or more sets of resources, each of the one or more sets of resources corresponding to a respective pairing of a respective bandwidth part and a respective component carrier; and performing measurements based at least in part on the one or more reference signals to obtain the one or more measurements associated with the second device.

Aspect 24: The method of aspect 23, further comprising: transmitting channel state information for one or more pairings of respective component carriers and bandwidth parts based at least in part on performing the measurements.

Aspect 25: The method of any of aspects 23 through 24, wherein performing the measurements comprises: measuring an energy expenditure associated with each respective pairing.

Aspect 26: The method of any of aspects 23 through 24, wherein performing the measurements comprises: measuring a current channel state information corresponding to each respective pairing.

Aspect 27: The method of any of aspects 23 through 24, wherein performing the measurements comprises: measuring an average channel state information corresponding to each respective pairing.

Aspect 28: The method of aspect 27, wherein measuring the average channel state information comprises: measuring an accumulation of acknowledgement or negative acknowledgement information corresponding to each pairing, an average charging rate across multiple transmissions measured for each pairing, an average statistic received from another device, or a combination thereof.

Aspect 29: The method of any of aspects 23 through 28, further comprising: receiving a measurement report indicating the measurements of the one or more reference signals, wherein transmitting the message indicating the configuration for performing the energy harvesting procedure is based at least in part on receiving the measurement report.

Aspect 30: The method of any of aspects 17 through 29, wherein transmitting the message indicating the configuration for performing the energy harvesting procedure comprises: transmitting the message from the second device, or a third device different from the second device and the first device.

Aspect 31: An apparatus for wireless communication at a first device, comprising a memory and a processor coupled to the memory and configured to perform a method of any of aspects 1 through 16.

Aspect 32: An apparatus for wireless communication at a first device, comprising at least one means for performing a method of any of aspects 1 through 16.

Aspect 33: A non-transitory computer-readable medium storing code for wireless communication at a first device, the code comprising instructions executable by a processor to perform a method of any of aspects 1 through 16.

Aspect 34: An apparatus for wireless communication at a first device, comprising a memory and a processor coupled to the memory and configured to perform a method of any of aspects 17 through 30.

Aspect 35: An apparatus for wireless communication at a first device, comprising at least one means for performing a method of any of aspects 17 through 30.

Aspect 36: A non-transitory computer-readable medium storing code for wireless communication at a first device, the code comprising instructions executable by a processor to perform a method of any of aspects 17 through 30.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed with a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor, but in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one place to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

The term “determine” or “determining” encompasses a wide variety of actions and, therefore, “determining” can include calculating, computing, processing, deriving, investigating, looking up (such as via looking up in a table, a database or another data structure), ascertaining and the like. Also, “determining” can include receiving (such as receiving information), accessing (such as accessing data in a memory) and the like. Also, “determining” can include resolving, selecting, choosing, establishing and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. An apparatus for wireless communication at a first device, comprising:
a memory; and
a processor coupled to the memory and configured to:
receive a message indicating a configuration for performing an energy harvesting procedure by the first device, the configuration indicating a pairing of a component carrier and a bandwidth part for the first device to use for performing the energy harvesting procedure, the pairing based at least in part on one or more measurements associated with the first device; and
monitor, as part of the energy harvesting procedure, for one or more signals from a second device using a set of resources that correspond to the pairing of the component carrier and the bandwidth part.

2. The apparatus of claim 1, wherein the processor is further configured to:
transmit, to the second device, a report indicating a second pairing of a second component carrier and a second bandwidth part that satisfies a performance criterion based at least in part on the one or more measurements associated with the first device.

3. The apparatus of claim 2, wherein the processor is further configured to:
receive a power headroom report from the second device, wherein transmitting the report is based at least in part on the power headroom report.

4. The apparatus of claim 2, wherein the processor is further configured to:
transmit the report including one or more communication link types and one or more pairings of a respective component carrier and a respective bandwidth part, wherein each of the one or more pairings corresponds to a respective communication link type of the one or more communication link types.

5. The apparatus of claim 2, wherein the processor is further configured to:
receive an indication of the one or more measurements from the second device, wherein transmitting the report is based at least in part on the one or more measurements.

6. The apparatus of claim 1, wherein the processor is further configured to:
combine two or more pairings of respective component carriers and respective bandwidth parts, wherein the set of resources corresponds to the combined two or more pairings of the respective component carriers and the respective bandwidth parts.

7. The apparatus of claim 1, wherein the processor is further configured to:
transmit, to the second device, a power headroom report indicating a transmit power availability of the first device, wherein the configuration for performing the energy harvesting procedure is based at least in part on the transmit power availability of the first device.

8. The apparatus of claim 1, wherein the processor is further configured to:
receive one or more reference signals using one or more sets of resources, each of the one or more sets of resources corresponding to a respective pairing of a respective bandwidth part and a respective component carrier; and
perform measurements based at least in part on the one or more reference signals to obtain the one or more measurements associated with the first device.

9. The apparatus of claim 8, wherein the processor is further configured to:
transmit channel state information for one or more pairings of respective component carriers and bandwidth parts based at least in part on performing the measurements.

10. The apparatus of claim 8, wherein, to perform the measurements, the processor is configured to:
measure an energy expenditure associated with each respective pairing.

11. The apparatus of claim 8, wherein, to perform the measurements, the processor is configured to:
measure a current channel state information corresponding to each respective pairing.

12. The apparatus of claim 8, wherein, to perform the measurements, the processor is configured to:
measure an average channel state information corresponding to each respective pairing.

13. The apparatus of claim 12, wherein, to measure the average channel state information, the processor is configured to:
measure an accumulation of acknowledgement or negative acknowledgement information corresponding to each pairing, an average charging rate across multiple transmissions measured for each pairing, an average statistic received from another device, or a combination thereof.

14. The apparatus of claim 8, wherein the processor is further configured to:
transmit a measurement report indicating the measurements of the one or more reference signals, wherein receiving the message indicating the configuration for performing the energy harvesting procedure is based at least in part on transmitting the measurement report.

15. The apparatus of claim 1, wherein the processor is further configured to:
receive, from the second device and using the set of resources that correspond to the pairing of the component carrier and the bandwidth part, at least one signal of the one or more signals, the at least one signal comprising a data signal;
decode, the at least one signal based at least in part on the at least one signal comprising the data signal; and
perform the energy harvesting procedure to convert at least a portion of the at least one signal to power to be used at the first device.

16. An apparatus for wireless communication at a first device, comprising:
a memory; and
a processor coupled to the memory and configured to:
transmit a message indicating a configuration for performing an energy harvesting procedure by a second device, the configuration indicating a pairing of a component carrier and a bandwidth part for the second device to use for performing the energy harvesting procedure, the pairing based at least in part on one or more measurements associated with the second device; and
transmit, as part of the energy harvesting procedure, one or more signals to the second device using a set of resources that correspond to the pairing of the component carrier and the bandwidth part.

17. The apparatus of claim 16, wherein the processor is further configured to:
receive, from the second device, a report indicating a second pairing of a second component carrier and a second bandwidth part that satisfies a performance criterion based at least in part on the one or more measurements associated with the second device.

18. The apparatus of claim 17, wherein the processor is further configured to:
transmit a power headroom report to the second device, wherein receiving the report is based at least in part on the power headroom report.

19. The apparatus of claim 17, wherein the processor is further configured to:
receive the report including one or more communication link types and one or more pairings of a respective component carrier and a respective bandwidth part, wherein each of the one or more pairings corresponds to a respective communication link type of the one or more communication link types.

20. The apparatus of claim 17, wherein the processor is further configured to:
transmit an indication of the one or more measurements to the second device, wherein receiving the report is based at least in part on the one or more measurements.

21. The apparatus of claim 16, wherein the processor is further configured to:
receive, from the second device, a power headroom report indicating a transmit power availability of the first device, wherein the configuration for performing the energy harvesting procedure is based at least in part on the transmit power availability of the first device.

22. The apparatus of claim 16, wherein the processor is further configured to:
transmit one or more reference signals using one or more sets of resources, each of the one or more sets of resources corresponding to a respective pairing of a respective bandwidth part and a respective component carrier; and
perform measurements based at least in part on the one or more reference signals to obtain the one or more measurements associated with the second device.

23. The apparatus of claim 22, wherein the processor is further configured to:
transmit channel state information for one or more pairings of respective component carriers and bandwidth parts based at least in part on performing the measurements.

24. The apparatus of claim 22, wherein, to perform the measurements, the processor is configured to:
measure an energy expenditure associated with each respective pairing.

25. The apparatus of claim 22, wherein, to perform the measurements, the processor is configured to:
measure a current channel state information corresponding to each respective pairing.

26. The apparatus of claim 22, wherein, to perform the measurements, the processor is configured to:
measure an average channel state information corresponding to each respective pairing.

27. The apparatus of claim 26, wherein, to measure the average channel state information, the processor is configured to:
measure an accumulation of acknowledgement or negative acknowledgement information corresponding to each pairing, an average charging rate across multiple transmissions measured for each pairing, an average statistic received from another device, or a combination thereof.

28. The apparatus of claim 16, wherein, to transmit the message indicating the configuration for performing the energy harvesting procedure, the processor is configured to:
transmit the message from the second device, or a third device different from the second device and the first device.

29. A method for wireless communication at a first device, comprising:
receiving a message indicating a configuration for performing an energy harvesting procedure by the first device, the configuration indicating a pairing of a component carrier and a bandwidth part for the first device to use for performing the energy harvesting procedure, the pairing based at least in part on one or more measurements associated with the first device; and
monitoring, as part of the energy harvesting procedure, for one or more signals from a second device using a set of resources that correspond to the pairing of the component carrier and the bandwidth part.

30. A method for wireless communication at a first device, comprising:
transmitting a message indicating a configuration for performing an energy harvesting procedure by a second device, the configuration indicating a pairing of a component carrier and a bandwidth part for the second device to use for performing the energy harvesting procedure, the pairing based at least in part on one or more measurements associated with the second device; and
transmitting, as part of the energy harvesting procedure, one or more signals to the second device using a set of resources that correspond to the pairing of the component carrier and the bandwidth part.
